(19) United States
(12) Patent Application Publication
(10) Pub. No.: US 2026/0193005 A1
(43) Pub. Date: Jul. 9, 2026

(54) PACKAGING ASSEMBLY FOR AEROSOL GENERATING ARTICLES

(71) Applicant: PHILIP MORRIS PRODUCTS S.A., Neuchatel (CH)

(72) Inventors: Rui Nuno Rodrigues Alves Batista, Morges (CH); Maria Gomez Lueso, Lausanne (CH)

(21) Appl. No.: 19/134,257

(22) PCT Filed: Dec. 21, 2023
(86) PCT No.: PCT/EP2023/087268

§ 371 Date: May 30, 2025

(30) Foreign Application Priority Data
Dec. 23, 2022 (EP) 22216422.0

(51) Int. Cl. B65D 73/00; A24D 1/20; A24F 15/01

(52) U.S. Cl. CPC B65D 73/0078; A24D 1/20; A24F 15/01

(57) ABSTRACT

A packaging assembly (80) is provided comprising a container (870) and an aerosol-generating article (800). The container (870) comprises first and second planar wall portions (871, 872). The first planar wall portion (871) comprises an attachment surface (8711). The aerosol-generating article (800) comprises opposed first and second outward facing surfaces, and a portion of sensorial media (830). The portion of sensorial media (830) is contained within the aerosol-generating article (800). The portion of sensorial media (830) is in fluid communication with an opening defined in the second outward facing surface of the aerosol-generating article (800). The second outward-facing surface of the aerosol-generating article (800) is releasably attached to the attachment surface (8711) of the first planar wall portion (871) of the container (870) to thereby close and seal the opening. The first and second planar wall portions (871, 872) are separated by a first fold region (874). The second planar wall portion (872) is foldable about the first fold region (874) between a closed position and an open position. In the closed position the second planar wall portion (872) covers at least part of the first outward-facing surface of the aerosol-generating article (800).

The present disclosure relates to an aerosol-generating article for use with an aerosol-generating device. The present disclosure also relates to an assembly formed of a plurality of aerosol-generating articles attached to a supporting sheet. The present disclosure also relates to an assembly formed of a plurality of aerosol-generating articles and a packaging container. The present disclosure also relates to a packaging assembly.

In the field of aerosol-generating articles for delivering an aerosol to a user, it is known for such aerosol-generating articles to be circular in cross-section and to extend between opposed first and second open ends. Such an aerosol-generating article typically contains a portion of aerosol-forming substrate having a cylindrical shape corresponding to the circular cross-section of the article. It is known for heat to be applied to the aerosol-forming substrate in order to evolve vapour from the aerosol-forming substrate. By way of example, heat may be applied to the aerosol-forming substrate by insertion of a heating element within the substrate to heat the substrate from within, or by surrounding the aerosol-forming substrate with a heating element to heat the substrate from outside of the aerosol-generating article. However, the circular cross-section of known aerosol-generating articles can result in non-uniform heating of the aerosol-forming substrate. More specifically, regions of the substrate located further away from the heating element can end up being heated to a lower level than regions of the substrate located nearer to the heating element. Such non-uniform heating can result in the aerosol-forming substrate being only partially depleted at the end of a usage session.

It is therefore desired to provide an aerosol-generating article which overcomes one or more of the issues mentioned above.

In a first aspect of the present disclosure, there is provided an aerosol-generating article for use with an aerosol-generating device. The aerosol-generating article comprises a first sheet and a portion of sensorial media. The first sheet may be configured to be thermally conductive and comprise an impermeable surface. The portion of sensorial media may be disposed directly on the impermeable surface of the first sheet.

The aerosol-generating article may be configured for coupling to an aerosol-generating device having a heating arrangement positioned to impart heat to the thermally conductive first sheet. The heating arrangement of the aerosol-generating device is preferably electrically powered. By way of example, the heating arrangement may be in the form of a resistive heating element. In use, the resistive heating element may be positioned in thermal proximity to the first sheet to impart heat to the thermally conductive first sheet. Alternatively, the heating arrangement may be in the form of an inductive heating arrangement having an inductor for imparting heat to a susceptor, with application of an alternating current to the inductor causing heating of the susceptor positioned proximate the inductor by one or both of eddy current heating and magnetic hysteresis heating. The inductive heating arrangement of the aerosol-generating device may include the susceptor, with the susceptor positioned in thermal proximity to the first sheet to impart heat to the thermally conductive first sheet.

The thermally conductive nature of the first sheet may facilitate the conducting of heat by the first sheet and its transfer to the sensorial media disposed on the impermeable surface of the first sheet. The impermeable surface of the first sheet avoids or reduces loss of any moisture content of the sensorial media through absorption by the first sheet.

Preferably, the aerosol-generating article comprises opposed first and second outward-facing planar surfaces. The first and second outward-facing surfaces may be parallel to each other. Conveniently, a separation between the first and second outward-facing planar surfaces may define a thickness of the aerosol-generating article. Preferably, the first outward-facing planar surface is an outward-facing surface of the first sheet. Advantageously, the aerosol-generating article further comprises a second sheet overlying the first sheet and the portion of sensorial media, the second sheet removably and directly attached to the first sheet, wherein the second outward-facing planar surface is an outward-facing surface of the second sheet.

Preferably, the portion of sensorial media is disposed directly on the impermeable surface such that the portion of sensorial media is inwardly offset from a peripheral edge of the impermeable surface of the first sheet. As described in more detail in subsequent paragraphs, the presence of such an offset may allow for a second sheet to be placed over the first sheet and sealed thereto, thereby sealing the portion of sensorial media between the first and second sheets. Sealing the portion of sensorial media in this manner facilitates maintaining the freshness of the sensorial media and avoids potential contamination of the sensorial media by foreign bodies.

The aerosol-generating article may have a single portion of the sensorial media.

However, advantageously there may be a plurality of portions of sensorial media. The plurality of portions of sensorial media may each be disposed directly on the impermeable surface of the first sheet such that each one of the plurality of portions of sensorial media is inwardly offset from a peripheral edge of the impermeable surface of the first sheet.

In some embodiments, the thermally conductive nature of the first sheet and its ability to conduct heat quickly and efficiently may be more a consequence of the thickness of the first sheet being kept to a minimum, rather than due to the physical properties of the materials from which the first sheet is formed. The thickness of the first sheet is preferably minimised whilst still providing adequate strength to the first sheet, with the minimal thickness of the first sheet allowing for fast and efficient conduction of heat across the thickness of the first sheet. This, in turn, may allow for efficient transfer of heat to sensorial media disposed on the first sheet when the first sheet is in direct contact with or adjacent to a heater element.

Preferably, the first sheet comprises a paper-based material, more preferably a paper-based material that can resist high temperatures without degradation of its functional characteristics. The first sheet preferably comprises or consists of a paper-based foil. The paper-based foil may comprise a lamination of a layer of paper-based material and a metallic layer. The metallic layer may be formed from aluminium or another thermally conductive metallic material. Advantageously, paper-based materials are chosen which are designed for heating at temperatures of up to 280° C. Exemplary paper-based materials include parchment papers, vegetable parchments, or baking papers, being cellulose-based composite materials that have been processed by parchmentisation. Parchment paper is advantageous due to having characteristics of heat resistance (including high stability at high temperatures), water resistance, high density, resistance to glycerin and most common oils used in the food & beverage industry. Additionally, such materials do not typically release particles or fibres (even when heated) and also retain favourable non-stick properties. The use of paper-based materials also provides a sustainable alternative to the use of plastics. The first sheet may comprise a lamination of different layers of paper-based materials.

The first sheet may comprise a thin layer or coating of impermeable material. Preferably, the layer or coating of impermeable material is applied to a surface of a paper-based layer of the first sheet, such as those described above. Where the first sheet is formed of a lamination of a layer of paper-based material and a metallic layer, the thin layer or coating of impermeable material may be applied to the metallic layer. By way of example, the layer or coating of impermeable material may have a thickness in a range of between 0.75 microns and 1.5 microns. Such a layer or coating of impermeable material provides an impermeable surface for the first sheet on which the sensorial media may be disposed. The impermeable layer or coating preferably has a composition compliant with the regulations of the U.S. Food & Drug Administration (FDA), such as FDA CFR (Code of Federal Regulations) Title 21. Suitable materials for the layer or coating of impermeable material include dispersions based on co-polymers consisting of acrylic ester and styrene, or based on styrene-butadiene co-polymers, applied during paper processing as aqueous dispersions of co-polymers of styrene-butadiene with a solids content of approximately 50%. Suitable dispersions may contain silica-based compounds, as well as ceramic-based solutions.

In some examples, the first sheet may lack a paper-based layer, with the first sheet instead comprising or consisting of a layer of thermally conductive material. Preferably, the thermally conductive material may comprise or consist of aluminium or another thermally conductive metallic material. The layer of thermally conductive material may form the impermeable surface of the first sheet on which the portion of sensorial media is directly disposed. Alternatively, the first sheet may comprise or consist of a lamination of a thermally conductive material (for example, aluminium or another thermally conductive metallic material) and a layer or coating of impermeable material. The layer or coating of impermeable material may be as described above for where the first sheet has a paper-based layer.

The first sheet may comprise or consist of a material having a thermal conductivity of at least 10 W/mK. Conveniently, the material is a metallic material. Advantageously, the metallic material comprises or consists of aluminium.

Preferably, the impermeable surface of the first sheet is configured to be water impermeable.

Conveniently, the first sheet may have a permeability in a range of between 1 to 5 Coresta units.

The first sheet may have a basis weight in a range of between 45 and 140 grammes per metre, or preferably between 50 and 110 grammes per metre.

Preferably, the aerosol-generating article comprises a second sheet overlying the impermeable surface of the first sheet and the portion of sensorial media. The second sheet may comprise an impermeable surface. Preferably the second sheet comprises a biopolymer compliant with the regulations of the U.S. Food & Drug Administration (FDA), such as FDA CFR (Code of Federal Regulations) Title 21. Advantageously, the second sheet may be formed from one or more polymers to render the second sheet wholly or partially transparent. Transparency of the second sheet may allow a user to view the sensorial media contained within the aerosol-generating article between the first and second sheets prior to use of the aerosol-generating article; for example, prior to insertion of the aerosol-generating article into an aerosol-generating device. The second sheet may comprise or consist of polymeric compound compositions incorporating vinyl-based polymers and co-polymers, polyurethane, acrylic, cellulose and its derivatives, and compounds of thereof. The second sheet may be formed as a peelable foil. The peelable foil may comprise aluminium. It will also be understood that the second sheet may have a composition and structure in common with that of the first sheet.

The impermeable surface of the second sheet is preferably removably and directly attached to the impermeable surface of the first sheet along a seal path surrounding the portion of sensorial media. The attachment of the first and second sheets along the seal path facilitates sealing the sensorial media between the first and second sheets, thereby helping to maintain freshness of the sensorial media, and avoid contamination of the sensorial media with foreign bodies and/or drying-out of the sensorial media. The sealing of the first and second sheets to each other may be such that the first and second sheets are in intimate contact with the sensorial media, preferably with no air gaps being present between the sensorial media and opposing surfaces of the first and second sheets.

Prior to coupling of the aerosol-generating article to an aerosol-generating device to commence a usage session, conveniently a user may detach the second sheet from the first sheet to expose the sensorial media. When the aerosol-generating article is coupled to the device with the sensorial media exposed, vapour generated through heating of the sensorial media would be able to escape from the confines of the article. For example, where an airflow passes over the exposed sensorial media, the vapour evolved through heating of the sensorial media may mix with the airflow to form an entrained airflow. On cooling, the entrained airflow may condense form an aerosol for inhalation by the user.

Preferably, a separation between respective outward-facing surfaces of the first and second sheets defines a thickness of the aerosol-generating article.

The removable attachment of the impermeable surface of the second sheet to the impermeable surface of the first sheet is advantageously configured to hermetically seal the portion of sensorial media between the impermeable surfaces of the first and second sheets.

The provision of a hermetic seal facilitates retaining the freshness and moisture level of the sensorial media.

Advantageously, the impermeable surface of the second sheet is peelably attached to the impermeable surface of the first sheet. The provision of a peelable attachment between the impermeable surfaces of the first and second sheets provides for ease of detaching the second sheet from the first sheet. Conveniently, the second sheet comprises a tab for a user to engage therewith to thereby peel the second sheet away from the first sheet. The second sheet may be formed as a peelable foil. The peelable foil may comprise aluminium.

Preferably, one or both of the impermeable surfaces of the first and second sheets comprise or are overlaid with an adhesive. The adhesive is preferably configured to provide the removable attachment of the impermeable surface of the second sheet to the impermeable surface of the first sheet. Advantageously, the impermeable surfaces of the first and second sheets are free of adhesive in all locations corresponding to where the portion of sensorial media is overlaid by the first and second sheets. The lack of adhesive in regions of the impermeable surfaces of the first and second sheets which overlie the sensorial media avoids the sensorial media becoming adhered to one of the first and second sheets, and also avoids consequent contamination of the sensorial media by the adhesive. Conveniently, the adhesive is provided as a layer of one or both of the first and second sheets.

Preferably, the impermeable surface of the second sheet is configured to be water impermeable.

Conveniently, the second sheet has a permeability in a range of between 1 to 5 Coresta units.

Where the first sheet comprises a paper-based layer, the first sheet may have a thickness in a range of between 0.07 millimetres to 0.75 millimetres, preferably between 0.10 to 0.35 millimetres. Where the aerosol-generating article also includes a second sheet in which the second sheet comprises a paper-based layer, the second sheet may also have a thickness within the same ranges as detailed here for the first sheet.

In other examples, one or both of the first sheet and (where present) the second sheet preferably has a thickness in a range of between 0.5 and 100 microns, or preferably between 0.5 and 75 microns, or preferably between 0.5 and 50 microns, or preferably between 0.5 and 25 microns, or preferably between 0.5 and 10 microns, or preferably between 0.5 and 5 microns, or preferably between 1.1 and 4.5 microns, or preferably between 1.1 and 3 microns, or preferably between 1.1 and 2 microns. The thickness ranges recited in this paragraph are particularly applicable to where the first sheet or (where present) the second sheet lack a paper-based layer, with the lack of a paper-based layer allowing a reduced thickness for the first or second sheets. The thickness ranges recited in this paragraph may apply where the first or second sheets comprise or consist of a layer of thermally conductive material (such as a layer of aluminium or other thermally conductive metallic material) laminated with a layer or coating of impermeable material, but without the presence of a paper-based layer.

The sensorial media may comprise any one or more of tobacco, nicotine, botanicals, cannabinoid, and a flavouring agent. Preferably, the sensorial media comprises or consists of homogenised tobacco. Further, the sensorial media may also comprise homogenised tobacco and an aerosol former.

The portion of sensorial media may have a gel composition. Preferably, the gel composition comprises nicotine. The gel composition may comprise between 1% and 3% wt nicotine. The gel composition may comprise between 80% and 90% wt glycerol, and a total weight of water and glycerol in a range of between 85% and 95% wt. The gel composition may comprise between 2% and 7% wt of a gelling agent. The gel composition may comprise between 1% and 4% wt of a single flavouring agent or a blend of flavouring agents. Preferably, the gel composition comprises between 1% and 2% wt of a single flavouring agent or a blend of flavouring agents.

The flavouring agent(s) may comprise one or more of a complex volatile oil, anise oil, aldehyde, vanillin, ginger oil, peppermint oil, lemongrass oil, tobacco extract oil, menthol oil, or combinations thereof.

Preferably the aerosol-generating article comprises a plurality of portions of sensorial media, as opposed to a single portion of sensorial media. At least one of the portions of sensorial media may have a different material composition to the other portions.

Preferably, in an example in which the aerosol-generating article comprises a plurality of portions of sensorial media, the plurality of portions are successively arranged along a length direction of the first sheet. The length direction of the first sheet may correspond to a length direction of the aerosol-generating article. Each of the portions may be spatially separated from the other portions.

The aerosol-generating article may have a length, a width and a thickness. Preferably, the ratio of the width to the thickness is greater than 5, or greater than 10, or greater than 20, or greater than 40. Where the article includes a second sheet as described in preceding paragraphs, a separation between respective outward-facing surfaces of the first and second sheets preferably defines the thickness of the aerosol-generating article. The thinner the aerosol-generating article, the easier it is likely to be to achieve uniform heating through the thickness of the sensorial media of the aerosol-generating article when applying heat to one of the respective outward-facing surfaces of the first and second sheets.

The thickness of the aerosol-generating article is preferably 1 millimetre or less, or more preferably 0.75 millimetres or less, or more preferably 0.5 millimetres or less. The thickness of the aerosol-generating article may be greater than 0.05 millimetres, or greater than 0.1 millimetres.

The length of the aerosol-generating article may be greater than 15 millimetres, or preferably in a range of between 15 millimetres and 100 millimetres, or preferably in a range of between 15 millimetres and 75 millimetres, or preferably in a range of between 15 millimetres and 65 millimetres, or preferably in a range of between 20 millimetres and 65 millimetres, or preferably in a range of between 28 millimetres and 62 millimetres, or preferably in a range of between 28 millimetres and 48 millimetres, or preferably in a range of between 35 millimetres and 48 millimetres.

The width of the aerosol-generating article may be greater than 5 millimetres, or preferably in a range of between 5 millimetres and 40 millimetres, or preferably in a range of between 5 millimetres and 31 millimetres, or preferably in a range of between 8 millimetres and 31 millimetres, or preferably in a range of between 11 millimetres and 25 millimetres.

It will be appreciated that the length, width and thickness dimensions of the aerosol-generating article may be a function of the size of the aerosol-generating device with which the aerosol-generating article is designed to be used. Where the aerosol-generating device incorporates a heating arrangement for heating the sensorial media of the aerosol-generating article, the dimensions of the aerosol-generating article may be a function of the size of the heating arrangement, and vice-versa. Where the heating arrangement of the aerosol-generating device is configured to apply a uniform level of heating over a predetermined area, it is preferred that the aerosol-generating article be positioned in proximity to the heating arrangement so that the sensorial media lies wholly within this predetermined area.

Preferably, the aerosol-generating article is generally flat. The aerosol-generating article preferably has a thickness defined by a separation between opposing first and second major surfaces of the aerosol-generating article, the opposing major surfaces each being planar. Preferably, an outward-facing surface of the first sheet defines the first major surface. Where the aerosol-generating article includes a second sheet as discussed above, preferably an outward-facing surface of the second sheet defines the second major surface.

The aerosol-generating article may define a generally parallelepiped profile.

The aerosol-generating article may be generally rectangular in plan.

The first sheet may be generally rectangular in plan. Where the aerosol-generating article includes a second sheet as discussed above, preferably the second sheet is generally rectangular in plan.

Preferably, the first sheet is generally planar. Where the aerosol-generating article includes a second sheet as discussed above, preferably the second sheet is generally planar.

In a second aspect of the present disclosure, there is provided an aerosol-generating article for use with an aerosol-generating device. The aerosol-generating article comprises a first sheet and a portion of sensorial media. By way of example, the aerosol-generating article may be as described in any of the preceding paragraphs. The first sheet may comprise or consist of a metallic layer. The portion of sensorial media may be disposed directly on the first sheet.

A metallic layer is likely to possess characteristics of being thermally conductive and impermeable. So, the provision of a metallic layer for the first sheet may facilitate the conducting of heat by the metallic layer and its transfer to the sensorial media disposed on the first sheet. Further, the provision of a metallic layer for the first sheet may also help to avoid or reduce loss of any moisture content of the sensorial media through absorption by the first sheet. Advantageously, the metallic layer comprises or consists of aluminium.

In a third aspect of the present disclosure, there is provided an aerosol-generating article for use with an aerosol-generating device. The aerosol-generating article comprises a frame, a first sheet and a portion of sensorial media. The frame comprises opposed first and second surfaces and a cavity. The opposed first and second surfaces define a thickness of the frame. The frame encloses the cavity. The cavity may extend through the thickness of the frame. The first sheet may be fixed to the first surface of the frame to overlie the cavity. The portion of sensorial media may be disposed directly on the first sheet within the cavity. The second surface of the frame may be peelably attached to an impermeable surface of an element to thereby close the cavity and seal the portion of sensorial media within the cavity.

When the second surface of the frame of the aerosol-generating article is attached to the impermeable surface of the element, the portion of sensorial media is sealed within the aerosol-generating article by the combination of the frame, the first sheet and the element. This facilitates maintaining the freshness of the sensorial media and avoids potential contamination of the sensorial media by foreign bodies. The impermeable surface of the element avoids or reduces loss of any moisture content of the sensorial media through absorption by the element.

The cavity of the frame provides a space for containment of the sensorial media.

Preferably, the aerosol-generating article comprises opposed first and second outward-facing planar surfaces. The first and second outward-facing surfaces may be parallel to each other. Conveniently, a separation between the first and second outward-facing planar surfaces defines a thickness of the aerosol-generating article. Preferably, the first outward-facing planar surface is an outward-facing surface of the first sheet. The second outward-facing planar surface may be the second surface of the frame.

By way of example, the first sheet may be as described in any of the preceding paragraphs.

Preferably, the fixation of the first sheet to the first surface of the frame is configured to define a hermetic seal therebetween. Similarly, preferably the peelable attachment of the second surface of the frame to the impermeable surface of the element is configured to define a hermetic seal therebetween.

The provision of a hermetic seal between the first sheet and the first surface of the frame and between the second surface of the frame and the impermeable surface of the element may facilitate maintaining freshness of the sensorial media, and avoiding contamination of the sensorial media with foreign bodies and/or drying-out of the sensorial media.

Preferably, a separation distance between an outward-facing surface of the first sheet and the second surface of the frame may define a thickness of the aerosol-generating article.

The element may take many forms. The element may correspond to the second sheet as described in any of the preceding paragraphs. Preferably, the element is a peelable lid, the aerosol-generating article comprising the peelable lid. Removal of the peelable lid from the frame would thereby expose the sensorial media disposed within the cavity of the frame. When the aerosol-generating article is coupled to an aerosol-generating device with the sensorial media exposed, vapour generated through heating of the sensorial media would be able to escape from the confines of the article. For example, where an airflow passes over the exposed sensorial media, the vapour evolved through heating of the sensorial media may mix with the airflow to form an entrained airflow. On cooling, the entrained airflow may condense form an aerosol for inhalation by the user.

Preferably, a separation distance between respective outward-facing surfaces of the first sheet and the peelable lid defines a thickness of the aerosol-generating article.

Preferably, one or both of the second surface of the frame and the impermeable surface of the peelable lid comprise or are overlaid with an adhesive, the adhesive configured to provide the peelable attachment between the second surface of the frame and the peelable lid. Advantageously, the peelable lid is free of adhesive in all locations corresponding to where the peelable lid overlies the cavity. In this manner, direct contact between the adhesive and the sensorial media may be avoided, thereby reducing the risk of the sensorial media being contaminated by the adhesive or becoming adhered to the adhesive. Conveniently, the adhesive may be provided as a layer of the peelable lid.

The peelable lid may be formed as a peelable foil. The peelable foil may comprise aluminium.

The element may be a sheet of a size suitable for the peelable attachment thereto of one or more of the aerosol-generating articles. The sheet (including the one or more aerosol-generating articles attached thereto) may be inserted within a packaging container. The sheet may comprise a paper-based substrate. The paper-based substrate may comprise paperboard. The sheet preferably comprises or consists of a paper-based foil. The sheet may comprise a layer of paper-based substrate and a layer or coating of impermeable material. Suitable materials for the layer or coating of impermeable material include dispersions based on co-polymers consisting of acrylic ester and styrene, or based on styrene-butadiene co-polymers, applied during paper processing as aqueous dispersions of co-polymers of styrene-butadiene with a solids content of approximately 50%. Suitable dispersions may contain silica-based compounds, as well as ceramic-based solutions.

Advantageously, the element may be a wall of a packaging container, the wall configured for the peelable attachment thereto of one or more of the aerosol-generating articles.

Preferably, the frame comprises a paper-based material. The frame may have a basis weight of between 200 and 500 grammes per metre, or preferably between 250 and 400 grammes per metre. A high level of basis weight is associated with an increasing level of flexural stiffness for the frame, thereby helping to ensure that the aerosol-generating article is able to maintain its shape without folding or buckling when peeled away from the impermeable surface of the element. Where the frame comprises paper-based material, the paper-based material may be overlaid with a coating or layer of impermeable material. Suitable materials for use as the layer or coating of impermeable material may include dispersions based on co-polymers consisting of acrylic ester and styrene, or based on styrene-butadiene co-polymers. Suitable dispersions may contain silica-based compounds, as well as ceramic-based solutions.

Preferably, the frame is configured to be water impermeable.

Conveniently, the frame may have a permeability in a range of between 1 and 3 Coresta units.

The greater the level of impermeability of the frame, the more protection is afforded against loss of moisture content from the sensorial media contained within the aerosol-generating article.

The frame may enclose a single cavity. In one example, a single portion of sensorial media may be arranged within the single cavity. In another example, a plurality of portions of sensorial media may be arranged within the single cavity. The plurality of portions of sensorial media may be successively arranged along a length direction of the first frame within the single cavity. Each one of the plurality of portions of sensorial media may be spatially separated from the other portions within the single cavity.

Preferably, the frame comprises an airflow inlet and an airflow outlet. The airflow inlet and airflow outlet may be in fluid communication with the single cavity to permit a flow of air between the airflow inlet and airflow outlet to pass over the sensorial media contained in the cavity. In this manner, an inflow of air originating from outside of the article may be directed into the cavity via the airflow inlet to flow over the sensorial media, thereby allowing vapour evolved from heating of the sensorial media to become entrained within the inflow of air. The entrained airflow may then exit the cavity via the airflow outlet for subsequent inhalation by a user.

In an alternative embodiment to the frame having a single cavity, the frame may instead enclose a plurality of cavities, the frame separately enclosing each one of the plurality of cavities. The presence of a plurality of cavities for the frame allows for a distinct portion of sensorial media to be located in a respective one of the plurality of cavities, thereby reducing the likelihood of contact between different portions of sensorial media. Preferably, fixation of the first sheet to the first surface of the frame and the peelable attachment of the second surface of the frame to the impermeable surface of the element are both configured to seal each one of the plurality of cavities from each other. Advantageously, the aerosol-generating article may comprise a plurality of portions of sensorial media, each one of the plurality of cavities containing at least one of the plurality of portions of sensorial media. Preferably, each one of the plurality of cavities contains a single one of the plurality of portions of sensorial media.

Preferably, the frame comprises an airflow inlet and an airflow outlet for each one of the plurality of cavities. The airflow inlet and airflow outlet may be configured to permit a flow of air between the airflow inlet and airflow outlet of the respective cavity to pass over the sensorial media contained in the respective cavity. Advantageously, the frame may comprise a common airflow inlet channel, each of the airflow inlets in fluid communication with the common airflow inlet channel. In a similar advantageous manner, the frame may comprise a common airflow outlet channel, each of the airflow outlets in fluid communication with the common airflow outlet channel.

Preferably, the common airflow outlet channel comprises a mixing chamber for mixing of the airflows received from each of the plurality of cavities via the respective airflow outlets. So, the mixing chamber may allow homogenous mixing of an entrained flow of air/vapour received from each of the cavities containing sensorial media.

By way of example, the sensorial media may be as described in any of the preceding paragraphs.

The sensorial media may comprise any one or more of tobacco, nicotine, botanicals, cannabinoid, and a flavouring agent. Preferably, the sensorial media comprises or consists of homogenised tobacco. Further, the sensorial media may also comprise homogenised tobacco and an aerosol former.

The portion of sensorial media may have a gel composition. Preferably, the gel composition comprises nicotine. The gel composition may comprise between 1% and 3% wt nicotine. The gel composition may comprise between 80% and 90% wt glycerol, and a total weight of water and glycerol in a range of between 85% and 95% wt. The gel composition may comprise between 2% and 7% wt of a gelling agent. The gel composition may comprise between 1% and 4% wt of a single flavouring agent or a blend of flavouring agents. Preferably, the gel composition comprises between 1% and 2% wt of a single flavouring agent or a blend of flavouring agents.

The flavouring agent(s) may comprise one or more of a complex volatile oil, anise oil, aldehyde, vanillin, ginger oil, peppermint oil, lemongrass oil, tobacco extract oil, menthol oil, or combinations thereof.

Preferably, the aerosol-generating article comprises a plurality of portions of sensorial media. At least one of the portions of sensorial media may have a different material composition to the other portions.

The aerosol-generating article may have a length, a width and a thickness. The ratio of the width to the thickness may be greater than 5, or greater than 10, or greater than 20, or greater than 40. The thickness may be 6 millimetres or less, or preferably 5.5 millimetres or less, or preferably 3.5 millimetres or less, or preferably in a range of between 1.25 millimetres and 3.5 millimetres. The thickness may be greater than 0.5 millimetre, or preferably greater than 1 millimetre. The length may be greater than 15 millimetres, or preferably in a range of between 15 millimetres and 100 millimetres, or preferably in a range of between 15 millimetres and 75 millimetres, or preferably in a range of between 15 millimetres and 65 millimetres, or preferably in a range of between 20 millimetres and 65 millimetres, or preferably in a range of between 28 millimetres and 62 millimetres, or preferably in a range of between 28 millimetres and 48 millimetres, or preferably in a range of between 35 millimetres and 48 millimetres. The width may be greater than 5 millimetres, or preferably in a range of between 5 millimetres and 40 millimetres, or preferably in a range of between 5 millimetres and 31 millimetres, or preferably in a range of between 8 millimetres and 31 millimetres, or preferably in a range of between 11 millimetres and 25 millimetres.

Preferably, the aerosol-generating article is generally flat.

Conveniently, the aerosol-generating article may define a generally parallelepiped profile.

The aerosol-generating article may be generally rectangular in plan.

Any one or more of the component parts of the aerosol-generating article may be rectangular in plan. In one example, the first sheet may be generally rectangular in plan. In another example, the peelable lid (when present as the “element”) may be generally rectangular in plan. In another example, the frame may be generally rectangular in plan.

Any one or more of the component parts of the aerosol-generating article may be generally planar. In one example, the first sheet may be generally planar. In another example, the opposed first and second surfaces of the frame may be generally planar.

In a fourth aspect of the present disclosure, there is provided an assembly comprising a plurality of aerosol-generating articles and a supporting sheet. The plurality of aerosol-generating articles may be peelably attached to an impermeable surface of the supporting sheet. By way of example, one or more of the aerosol-generating articles may be as described in any of the preceding paragraphs. Each of the aerosol-generating articles may comprise a frame, a first sheet and a portion of sensorial media. The frame comprises opposed first and second surfaces and a cavity. The opposed first and second surfaces define a thickness of the frame. The frame encloses the cavity. The cavity may extend through the thickness of the frame. The first sheet may be fixed to the first surface of the frame to overlie the cavity. The portion of sensorial media may be disposed directly on the impermeable surface of the first sheet within the cavity. For each of the aerosol-generating articles, the second surface of the frame may be peelably attached to the impermeable surface of the supporting sheet to thereby close the cavity and seal the portion of sensorial media within the cavity.

Having the plurality of aerosol-generating articles attached to the supporting sheet facilitates storing the aerosol-generating articles in a space efficient manner. The peelable attachment of the aerosol-generating articles to the supporting sheet provides for ease of removal of each aerosol-generating article from the supporting sheet for subsequent use. The “use” may include coupling of the aerosol-generating article to an aerosol-generating device for heating of the sensorial media exposed as a consequence of the article being detached from the sheet.

Preferably, the first sheet comprises a tab for a user to engage therewith to thereby peel the respective aerosol-generating article away from the supporting sheet.

Advantageously, the plurality of the aerosol-generating articles may be peelably attached to the impermeable surface of the supporting sheet to define an arrangement of one or more rows or columns.

The supporting sheet may comprise a paper-based substrate. The paper-based substrate may comprise paperboard. The supporting sheet preferably comprises or consists of a paper-based foil. The supporting sheet may comprise a layer of paper-based substrate and a layer or coating of impermeable material. Suitable materials for the layer or coating of impermeable material include dispersions based on co-polymers consisting of acrylic ester and styrene, or based on styrene-butadiene co-polymers, applied during paper processing as aqueous dispersions of co-polymers of styrene-butadiene with a solids content of approximately 50%. Suitable dispersions may contain silica-based compounds, as well as ceramic-based solutions.

Preferably, the supporting sheet comprises a first portion and a second portion separated from each other by a fold line. Each of the plurality of aerosol-generating articles may be peelably attached to the first portion of the supporting sheet, with the second portion folded about the fold line to at least partially overlie the plurality of aerosol-generating articles. The supporting sheet when folded in this manner facilitates shielding the aerosol-generating articles.

Advantageously, the assembly may further comprise a packaging container, the supporting sheet to which the plurality of aerosol-generating articles are peelably attached inserted inside the packaging container. The packaging container may contain a plurality of the supporting sheets.

In a fifth aspect of the present disclosure, there is provided an assembly comprising a plurality of aerosol-generating articles and a packaging container. By way of example, one or more of the aerosol-generating articles may be as described in any of the preceding paragraphs. Each of the aerosol-generating articles may comprise a frame, a first sheet, and a portion of sensorial media. The frame comprises opposed first and second surfaces and a cavity. The opposed first and second surfaces define a thickness of the frame. The frame may enclose the cavity. The cavity may extend through the thickness of the frame. The first sheet may be fixed to the first surface of the frame to overlie the cavity. The portion of sensorial media may be disposed directly on the impermeable surface of the first sheet within the cavity. The packaging container may comprise a wall having an impermeable surface. For each of the aerosol-generating articles, the second surface of the frame may be peelably attached to the impermeable surface of the wall of the packaging container to thereby close the cavity and seal the portion of sensorial media within the cavity.

Preferably, the first sheet comprises a tab for a user to engage therewith to thereby peel the respective aerosol-generating article away from the wall of the packaging container.

In one example, the impermeable surface of the wall may define an interior surface of the packaging container. In another example, the impermeable surface of the wall may define an exterior surface of the packaging container.

The wall of the packaging container may comprise a paper-based substrate. The paper-based substrate may comprise paperboard. The wall preferably comprises or consists of a paper-based foil. The wall may comprise a layer of paper-based substrate and a layer or coating of impermeable material. Suitable materials for the layer or coating of impermeable material include dispersions based on co-polymers consisting of acrylic ester and styrene, or based on styrene-butadiene co-polymers, applied during paper processing as aqueous dispersions of co-polymers of styrene-butadiene with a solids content of approximately 50%. Suitable dispersions may contain silica-based compounds, as well as ceramic-based solutions.

In a sixth aspect of the present disclosure, there is provided a packaging assembly comprising a container and an aerosol-generating article. By way of example, the aerosol-generating article may be as described in any of the preceding paragraphs. The container may comprise first and second planar wall portions, the first planar wall portion comprising an attachment surface. The aerosol-generating article may comprise opposed first and second outward-facing surfaces, and a portion of sensorial media contained within the aerosol-generating article. The portion of sensorial media may be in fluid communication with an opening defined in the second outward facing surface of the aerosol-generating article. The second outward-facing surface of the aerosol-generating article may be releasably attached to the attachment surface of the first planar wall portion of the container to thereby close and seal the opening. The first and second planar wall portions may be separated by a first fold region, the second planar wall portion foldable about the first fold region between a closed position and an open position. In the closed position the second planar wall portion covers at least part of the first outward-facing surface of the aerosol-generating article.

Preferably, the packaging assembly comprises a plurality of the aerosol-generating articles, the second outward-facing surface of each aerosol-generating article releasably attached to the attachment surface of the first planar wall portion of the container to thereby close and seal the opening of the respective aerosol-generating article.

Attachment of the aerosol-generating article to the attachment surface of the container to close and seal the opening of the cavity facilitates maintaining freshness of the sensorial media and avoiding contamination of the sensorial media with foreign bodies and/or drying-out of the sensorial media. The first and second planar wall portions may provide a generally thin and flat profile to the container, especially when the second planar wall portion is in the closed position.

The second planar wall portion in the closed position may help to provide a level of physical protection to the aerosol-generating article by shielding the article from impact damage. Conveniently, in the closed position the second planar wall portion may cover all of the first outward-facing surface of the aerosol-generating article.

Preferably, a separation between the first and second outward-facing surfaces of the aerosol-generating article defines a thickness of the aerosol-generating article.

Advantageously, the first and second planar wall portions of the container may be integrally formed as a single unitary sheet. Alternatively however, the first and second planar portions may be distinct structural entities coupled to each other directly or via an intermediate element.

Preferably, the container comprises a frangible interface for retaining the second planar wall portion in the closed position. Rupture of the frangible interface may allow the second planar wall portion to be displaced to the open position. Conveniently, the frangible interface may be provided between the first and second planar wall portions.

Advantageously, the container may comprise a third planar wall portion. The first and third planar wall portions may be separated by a second fold region, with the third planar wall portion foldable about the second fold region between a closed position and an open position. In the closed position of the second and third planar sheet portions, one of the second and third planar sheet portions may overlie the other of the second and third planar wall portions. The provision of a third planar wall portion in addition to the second planar wall portion may provide additional physical protection to the aerosol-generating article.

Advantageously, the first, second and third planar wall portions are integrally formed as a single unitary sheet. Alternatively however, the first, second and third planar portions may be distinct structural entities coupled to each other directly or via one or more intermediate elements.

Preferably, in the closed position of the second and third planar wall portions, the second and third planar wall portions in combination cover all of the first outward-facing surface of the aerosol-generating article.

Conveniently, the first and second fold regions may be positioned at opposite ends of the first planar wall portion.

Preferably, the container comprises a frangible interface for retaining the third planar wall portion in the closed position. Rupture of the frangible interface may allow the third planar wall portion to be displaced to the open position. Conveniently, the frangible interface may be provided between the second and third planar wall portions.

Advantageously, in the closed position of the second and third planar wall portions, opposing surfaces of the second and third planar wall portions may be adhered to each other. In this manner, the likelihood of the second and third planar wall portions inadvertently opening and exposing the aerosol-generating articles is reduced. The second and third planar wall portions are preferably adhered to each other in the closed position by one or more portions of adhesive, the one or more portions of adhesive comprising or consisting of a low-tack adhesive. By way of example, the low-tack adhesive may comprise a base of acrylate copolymer microspheres. The low-tack adhesive may further comprise one or more of aluminum powder, amorphous silica, sodium carbonate, sodium chromate, and polyaminoamide.

Any one or all of the first planar wall portion, the second planar wall portion and (where present) the third planar wall portion may comprise a paper-based substrate. The first, second or third planar wall portions preferably comprise or consist of a paper-based foil. The paper-based substrate may be supplemented with a layer or coating of impermeable material. The paper-based substrate may comprise paperboard. Paperboard is generally thicker than regular paper, usually over 0.30 millimetres in thickness, with a grammage (mass per unit area) above 250 g/m², and has certain desirable attributes such as foldability and rigidity. Paperboard may be single- or multi-ply in construction.

Any one or all of the first planar wall portion, the second planar wall portion and (where present) the third planar wall portion may have a basis weight of between 180 and 450 grammes per metre, preferably between 200 and 300 grammes per metre. Any one or all of the first planar wall portion, the second planar wall portion and (where present) the third planar wall portion may have a thickness in a range of between 0.35 and 2.5 millimetres.

Preferably, the first planar wall portion has a permeability in a range of between 1 and 10 Coresta units.

Advantageously, the attachment surface may be configured as an impermeable surface. Preferably, the attachment surface is configured to be water impermeable.

The greater the level of impermeability of the first planar wall portion and/or the attachment surface of the first planar wall portion, the more protection is afforded against loss of moisture content from the sensorial media.

Conveniently, the first planar wall portion may comprise an impermeable layer, the impermeable layer defining the attachment surface. Where the first planar wall portion also includes a paper-based substrate (as described above), the impermeable layer preferably overlies the paper-based substrate. So, the paper-based substrate and impermeable layer may provide a laminate structure for the first planar wall portion. The impermeable layer may have a thickness in a range of between 0.75 microns and 1.5 microns. Suitable materials for the layer of impermeable material include dispersions based on co-polymers consisting of acrylic ester and styrene, or based on styrene-butadiene co-polymers, applied during paper processing as aqueous dispersions of co-polymers of styrene-butadiene with a solids content of approximately 50%. Suitable dispersions may contain silica-based compounds, as well as ceramic-based solutions.

Preferably, the releasable attachment of the second outward-facing surface of the aerosol-generating article to the attachment surface of the first planar wall portion of the container is configured to define a hermetic seal therebetween. The presence of a hermetic seal may facilitate maintaining freshness and moisture content of the sensorial media, as well as reducing the likelihood of contamination of the sensorial media with foreign substances.

Advantageously, the releasable attachment of the second outward-facing surface of the aerosol-generating article to the attachment surface of the first planar wall portion of the container may be configured as a peelable attachment. The use of a peelable attachment to secure the aerosol-generating article to the first planar wall portion of the container may allow for ease of removal of the aerosol-generating article from the attachment surface of the first planar wall portion. Conveniently, the aerosol-generating article may comprise a tab for a user to engage therewith to thereby peel the aerosol-generating article away from the attachment surface of the first planar wall portion of the container.

Preferably, a plurality of the aerosol-generating articles are peelably attached to the attachment surface of the first planar wall portion to define an arrangement of one or more rows or columns. In this manner, the packaging assembly provides a space efficient way of storing a plurality of aerosol-generating articles so as to maintain the freshness and/or moisture content of the sensorial media contained in each article.

Preferably, the aerosol-generating article comprises a frame comprising opposed first and second surfaces and a cavity. The opposed first and second surfaces may define a thickness of the frame, the frame enclosing a cavity. The cavity may extend through the thickness of the frame to define the opening. The portion of sensorial media may be disposed within the cavity. The second surface of the frame may define the second outward-facing surface of the aerosol-generating article and be peelably attached to the attachment surface. The cavity of the frame provides a space for containment of the sensorial media.

Preferably, the aerosol-generating article further comprises a first sheet, the first sheet of the aerosol-generating article fixed to the first surface of the frame to overlie the cavity. In this manner, the first sheet may define the first outward-facing surface of the aerosol-generating article.

Advantageously, the first sheet may comprise a tab for a user to engage therewith to thereby peel the aerosol-generating article away from the attachment surface. Preferably, the fixation of the first sheet to the first surface of the frame is configured such that the first sheet remains fixed to the first surface of the frame if pulling on the tab to peel the aerosol-generating article away from the attachment surface. By way of example, the bond between the first sheet and the first surface of the frame is preferably stronger than the bond between the attachment surface of the first planar wall portion of the container and the second surface of the frame. This helps to ensure that when pulling on the tab to peel the aerosol-generating article away from the attachment surface, the bond between the attachment surface and the second surface of the frame fractures in preference to the bond between the first sheet and the first surface of the frame.

Preferably, the fixation of the first sheet to the first surface of the frame is configured to define a hermetic seal therebetween.

By way of example, the first sheet may be as described in any of the preceding paragraphs. Similarly, the frame may be as described in any of the preceding paragraphs.

Preferably, the frame comprises a paper-based material. The frame may have a basis weight of between 200 and 500 grammes per metre, or preferably between 250 and 400 grammes per metre. A high level of basis weight is associated with an increasing level of flexural stiffness for the frame, thereby helping to ensure that the aerosol-generating article is able to maintain its shape without folding or buckling when peeled away from the attachment surface. Where the frame comprises a paper-based material, the paper-based material may be overlaid with a coating or layer of impermeable material. Suitable materials for use as the layer or coating may include dispersions based on co-polymers consisting of acrylic ester and styrene, or based on styrene-butadiene co-polymers. Suitable dispersions may contain silica-based compounds, as well as ceramic-based solutions.

Preferably, the frame is configured to be water impermeable.

Conveniently, the frame may have a permeability in a range of between 1 to 3 Coresta units.

The greater the level of impermeability of the frame, the more protection is afforded against loss of moisture content from the sensorial media contained within the aerosol-generating article.

The frame may enclose a single cavity. In one example, a single portion of sensorial media may be arranged within the single cavity. In another example, a plurality of portions of sensorial media may be arranged within the single cavity. The plurality of portions of sensorial media may be successively arranged along a length direction of the first frame within the single cavity. Each one of the plurality of portions of sensorial media may be spatially separated from the other portions within the single cavity.

In an alternative embodiment to the frame having a single cavity, the frame may instead enclose a plurality of cavities, the frame separately enclosing each one of the plurality of cavities. Advantageously, the aerosol-generating article may comprise a plurality of portions of sensorial media, each one of the plurality of cavities containing at least one of the plurality of portions of sensorial media. Preferably, each one of the plurality of cavities contains a single one of the plurality of portions of sensorial media.

By way of example, the sensorial media may be as described in any of the preceding paragraphs.

The sensorial media may comprise any one or more of tobacco, nicotine, botanicals, cannabinoid, and a flavouring agent. Preferably, the sensorial media comprises or consists of homogenised tobacco. Further, the sensorial media may also comprise homogenised tobacco and an aerosol former.

The portion of sensorial media may have a gel composition. Preferably, the gel composition comprises nicotine. The gel composition may comprise between 1% and 3% wt nicotine. The gel composition may comprise between 80% and 90% wt glycerol, and a total weight of water and glycerol in a range of between 85% and 95% wt. The gel composition may comprise between 2% and 7% wt of a gelling agent. The gel composition may comprise between 1% and 4% wt of a single flavouring agent or a blend of flavouring agents. Preferably, the gel composition comprises between 1% and 2% wt of a single flavouring agent or a blend of flavouring agents.

The flavouring agent(s) may comprise one or more of a complex volatile oil, anise oil, aldehyde, vanillin, ginger oil, peppermint oil, lemongrass oil, tobacco extract oil, menthol oil, or combinations thereof.

Preferably, the aerosol-generating article comprises a plurality of portions of sensorial media. At least one of the portions of sensorial media may have a different material composition to the other portions.

Preferably, the first and second planar wall portions and optionally the third wall planar wall portion (where present) are each rectangular in plan.

In a closed state of the container the packaging assembly may have a thickness, wherein the thickness may be 20 millimetres or less, or preferably 15 millimetres or less, or preferably in a range of between 4 and 15 millimetres, or preferably in a range of between 6 and 13 millimetres.

In a closed state of the container the packaging assembly may have a length and a width. The length may be in a range of between 50 and 200 millimetres, or preferably in a range of between 50 and 180 millimetres, or preferably in a range of between 60 and 180 millimetres, or preferably in a range of between 80 and 150 millimetres. The width may be in a range of between 35 and 120 millimetres, or preferably in a range of between 45 and 110 millimetres, or preferably in a range of between 50 and 95 millimetres.

Advantageously, in a closed state of the container the packaging assembly may be generally flat.

Preferably, the packaging assembly defines a generally parallelepiped profile.

The packaging assembly is preferably generally rectangular in plan.

By way of example, the shape and dimensions of the aerosol-generating article may be as described in any of the preceding paragraphs.

The aerosol-generating article may have a length, a width and a thickness. Preferably, the ratio of the width to the thickness is greater than 5, or greater than 10, or greater than 20, or greater than 40.

The thickness of the aerosol-generating article is preferably 1 millimetre or less, or more preferably 0.75 millimetres or less, or more preferably 0.5 millimetres or less. The thickness may be greater than 0.05 millimetres, or greater than 0.1 millimetres.

The length of the aerosol-generating article may be greater than 15 millimetres, or preferably in a range of between 15 millimetres and 100 millimetres, or preferably in a range of between 15 millimetres and 75 millimetres, or preferably in a range of between 15 millimetres and 65 millimetres, or preferably in a range of between 20 millimetres and 65 millimetres, or preferably in a range of between 28 millimetres and 62 millimetres, or preferably in a range of between 28 millimetres and 48 millimetres, or preferably in a range of between 35 millimetres and 48 millimetres.

The width of the aerosol-generating article may be greater than 5 millimetres, or preferably in a range of between 5 millimetres and 40 millimetres, or preferably in a range of between 5 millimetres and 31 millimetres, or preferably in a range of between 8 millimetres and 31 millimetres, or preferably in a range of between 11 millimetres and 25 millimetres.

Preferably, the aerosol-generating article is generally flat. The generally flat structure of the aerosol-generating article may facilitate more uniform through-thickness heating of the sensorial media.

The aerosol-generating article may define a generally parallelepiped profile.

The aerosol-generating article may be generally rectangular in plan.

In a seventh aspect of the present disclosure, there is provided a packaging assembly comprising a first planar wall portion and an aerosol-generating article. By way of example, the first planar wall portion may form part of a container as described in any of the preceding paragraphs. Similarly, the aerosol-generating article may be as described in any of the preceding paragraphs. A planar surface of the first planar wall portion may define an attachment surface. The aerosol-generating article may comprise opposed first and second outward-facing surfaces and a portion of sensorial media contained within the aerosol-generating article. The portion of sensorial media may be in fluid communication with an opening defined in the second outward facing surface of the aerosol-generating article. The second outward-facing surface of the aerosol-generating article may be releasably attached to the attachment surface of the first planar wall portion to thereby close and seal the opening.

Preferably, the packaging assembly further comprises a container. The container may comprise the first planar wall portion and a second planar wall portion, the first and second planar wall portions separated by a first fold region. The second planar wall portion may be foldable about the first fold region between a closed position and an open position. In the closed position the second planar wall portion may cover at least part of the first outward-facing surface of the aerosol-generating article.

It will be understood that the features of any one of the aspects of the present disclosure may be combined with the features of any one or more of the other aspects of the present disclosure.

As used herein, the term “sensorial media” relates to a substrate capable of releasing one or more volatile compounds that can form an aerosol or a vapor or that can be brought into the gaseous phase. The sensorial media may serve as one or more of a nicotine provider, a flavor enhancer, and a volume enhancer. The sensorial media may be an aerosol-forming substrate. The aerosol-forming substrate may include an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The sensorial media may comprise any one or more of tobacco, nicotine, botanicals, cannabinoid, and a flavouring agent.

The sensorial media may comprise or consist of homogenised tobacco.

The sensorial media may comprise homogenised tobacco and an aerosol former.

The sensorial media may have a gel composition.

The gel composition may comprise nicotine.

The gel composition may comprise between 1% and 3% wt nicotine.

The gel composition may comprise between 80% and 90% wt glycerol. The gel composition may have a total weight of water and glycerol in a range of between 85% and 95% wt.

The gel composition may comprise between 2% and 7% wt of a gelling agent.

The gel composition may comprise between 1% and 4% wt of a single flavouring agent or a blend of flavouring agents. The gel composition may comprise between 1% and 2% wt of a single flavouring agent or a blend of flavouring agents.

The flavouring agent(s) may comprise one or more of a complex volatile oil, anise oil, aldehyde, vanillin, ginger oil, peppermint oil, lemongrass oil, tobacco extract oil, menthol oil, or combinations thereof.

As used herein, the term “aerosol-generating article” refers to an article comprising an aerosol-forming substrate that is capable of releasing volatile compounds that can form an aerosol. The aerosol-generating article may be disposable.

As used herein, the term “aerosol-forming substrate” refers to a substrate consisting of or comprising an aerosol-forming material that is capable of releasing volatile compounds upon heating to generate an aerosol.

The invention is defined in the claims. However, below there is provided a non-exhaustive list of non-limiting examples. Any one or more of the features of these examples may be combined with any one or more features of another example, embodiment, or aspect described herein.

Example Ex0a: An aerosol-generating article for use with an aerosol-generating device, comprising:
a first sheet, the first sheet comprising or consisting of a metallic layer;
a portion of sensorial media disposed directly on the first sheet.

Example Ex0b: An aerosol-generating article according to Ex0a, wherein the metallic layer comprises or consists of aluminium.

Example Ex1: An aerosol-generating article for use with an aerosol-generating device, for example an aerosol-generating article according to either one of Ex0a or Ex0b, the aerosol-generating article comprising:
a first sheet, the first sheet configured to be thermally conductive and comprising an impermeable surface;
a portion of sensorial media disposed directly on the impermeable surface of the first sheet.

Example Ex1a: An aerosol-generating article according to any one of Ex0a to Ex1, the aerosol-generating article having opposed first and second outward-facing planar surfaces, optionally the first and second outward-facing surfaces being parallel to each other.

Example Ex1 b: An aerosol-generating article according to Ex1a, wherein a separation between the first and second outward-facing planar surfaces defines a thickness of the aerosol-generating article.

Example Ex1c: An aerosol-generating article according to either one of Ex1a or Ex1 b, wherein the first outward-facing planar surface is an outward-facing surface of the first sheet.

Example Ex1d: An aerosol-generating article according to Ex1c, further comprising a second sheet overlying the first sheet and the portion of sensorial media, the second sheet removably and directly attached to the first sheet, wherein the second outward-facing planar surface is an outward-facing surface of the second sheet.

Example Ex2: An aerosol-generating article according to any one of Ex1 to Ex1d, wherein the portion of sensorial media is disposed directly on the impermeable surface such that the portion of sensorial media is inwardly offset from a peripheral edge of the impermeable surface of the first sheet.

Example Ex3: An aerosol-generating article according to Ex2, comprising a plurality of portions of sensorial media disposed directly on the impermeable surface of the first sheet such that each one of the plurality of portions of sensorial media is inwardly offset from a peripheral edge of the impermeable surface of the first sheet.

Example Ex4: An aerosol-generating article according to any one of Ex0a to Ex3, wherein the first sheet comprises or consists of a material having a thermal conductivity of at least 10 W/mK.

Example Ex5: An aerosol-generating article according to Ex4, wherein the material is a metallic material.

Example Ex6: An aerosol-generating article according to Ex5, wherein the metallic material comprises or consists of aluminium.

Example Ex7: An aerosol-generating article according to any one of Ex1 to Ex6, wherein the impermeable surface of the first sheet is configured to be water impermeable.

Example Ex8: An aerosol-generating article according to any one of Ex0a to Ex7, wherein the first sheet has a permeability in a range of between 1 and 5 Coresta units.

Example Ex9: An aerosol-generating article according to any one of Ex1 to Ex8, further comprising a second sheet overlying the impermeable surface of the first sheet and the portion of sensorial media, the second sheet comprising an impermeable surface, the impermeable surface of the second sheet removably and directly attached to the impermeable surface of the first sheet along a seal path surrounding the portion of sensorial media.

Example Ex10: An aerosol-generating article according to Ex9, wherein the first and second sheets are sealed to each other such that the first and second sheets are in intimate contact with the sensorial media.

Example Ex11: An aerosol-generating article according to Ex10, wherein the first and second sheets are sealed to each other such that no air gaps are present between the sensorial media and opposing surfaces of the first and second sheets.

Example Ex12: An aerosol-generating article according to any one of Ex9 to Ex11, wherein a separation between respective outward-facing surfaces of the first and second sheets defines a thickness of the aerosol-generating article.

Example Ex13: An aerosol-generating article according to any one of Ex9 to Ex12, wherein the removable attachment of the impermeable surface of the second sheet to the impermeable surface of the first sheet is configured to hermetically seal the portion of sensorial media between the impermeable surfaces of the first and second sheets.

Example Ex14: An aerosol-generating article according to any one of Ex9 to Ex13, wherein the impermeable surface of the second sheet is peelably attached to the impermeable surface of the first sheet.

Example Ex15: An aerosol-generating article according to Ex14, wherein the second sheet comprises a tab for a user to engage therewith to thereby peel the second sheet away from the first sheet.

Example Ex16: An aerosol-generating article according to either one of Ex14 or Ex15, wherein the second sheet is formed as a peelable foil.

Example Ex17: An aerosol-generating article according to Ex16, wherein the peelable foil comprises aluminium.

Example Ex18: An aerosol-generating article according to any one of Ex9 to Ex17, wherein one or both of the impermeable surfaces of the first and second sheets comprise or are overlaid with an adhesive, the adhesive configured to provide the removable attachment of the impermeable surface of the second sheet to the impermeable surface of the first sheet.

Example Ex19: An aerosol-generating article according to Ex18, wherein the impermeable surfaces of the first and second sheets are free of adhesive in all locations corresponding to where the portion of sensorial media is overlaid by the first and second sheets.

Example Ex20: An aerosol-generating article according to either one of Ex18 or Ex19, wherein the adhesive is provided as a layer of the second sheet.

Example Ex21: An aerosol-generating article according to any one of Ex9 to Ex20, wherein the impermeable surface of the second sheet is configured to be water impermeable.

Example Ex22: An aerosol-generating article according to any one of Ex0a to Ex21, wherein the first sheet comprises a layer of thermally conductive material.

Example Ex23: An aerosol-generating article according to Ex22, wherein the layer of thermally conductive material comprises or consists of aluminium.

Example Ex24: An aerosol-generating article according to either one of Ex22 or Ex23, wherein the layer of thermally conductive material forms the impermeable surface of the first sheet on which the portion of sensorial media is directly disposed.

Example Ex25: An aerosol-generating article according to any one of Ex22 to Ex24, wherein the first sheet comprises a laminate of the layer of thermally conductive material and at least one additional layer.

Example Ex26: An aerosol-generating article according to Ex25, wherein the at least one additional layer comprises a layer of a cellulose-based material or a paper-based material.

Example Ex27 An aerosol-generating article according to either one of Ex25 or Ex26, wherein the at least one additional layer comprises a layer of an impermeable material, optionally wherein the layer of impermeable material has a thickness in a range of between 0.75 and 1.5 microns.

Example Ex28: An aerosol-generating article according to Ex27, wherein the layer of impermeable material forms the impermeable surface of the first sheet on which the portion of sensorial media is directly disposed.

Example Ex29: An aerosol-generating article according to any one of Ex0a to Ex28, wherein one or both of the first sheet and (where present) the second sheet has a thickness in a range of between 0.07 millimetres and 0.75 millimetres, preferably between 0.10 millimetres and 0.35 millimetres, preferably wherein one or both of the first sheet and (where present) the second sheet comprise a layer of paper-based material.

Example Ex29a: An aerosol-generating article according to any one of Ex0a to Ex28, wherein one or both of the first sheet and (where present) the second sheet has a thickness in a range of between 0.5 and 100 microns, or optionally between 0.5 and 75 microns, or optionally between 0.5 and 50 microns, or optionally between 0.5 and 25 microns, or optionally between 0.5 and 10 microns, or optionally between 0.5 and 5 microns, or optionally between 1.1 and 4.5 microns, or optionally between 1.1 and 3 microns, or optionally between 1.1 and 2 microns, preferably wherein one or both of the first sheet and (where present) the second sheet lack a layer of paper-based material.

Example Ex30: An aerosol-generating article according to any one of Ex0a to Ex29a, wherein the first sheet has a basis weight in a range of between 45 and 140 grammes per metre, optionally between 50 and 110 grammes per metre.

Example Ex31: An aerosol-generating article according to any one of Ex0a to Ex30, wherein the sensorial media comprises any one or more of tobacco, nicotine, botanicals, cannabinoid, and a flavouring agent.

Example Ex32: An aerosol-generating article according to Ex31, wherein the sensorial media comprises or consists of homogenised tobacco.

Example Ex33: An aerosol-generating article according to Ex32, wherein the sensorial media comprises homogenised tobacco and an aerosol former.

Example Ex34: An aerosol-generating article according to any one of Ex0a to Ex33, wherein the portion of sensorial media has a gel composition, optionally the gel composition comprises nicotine.

Example Ex35: An aerosol-generating article according to Ex34, wherein the gel composition comprises between 1% and 3% wt nicotine.

Example Ex36: An aerosol-generating article according to either one of Ex34 or Ex35, wherein the gel composition comprises between 80% and 90% wt glycerol, and a total weight of water and glycerol in a range of between 85% and 95% wt.

Example Ex37: An aerosol-generating article according to any one of Ex34 to Ex36, wherein the gel composition comprises between 2% and 7% wt of a gelling agent.

Example Ex38: An aerosol-generating article according to any one of Ex34 to Ex37, wherein the gel composition comprises between 1% and 4% wt of a single flavouring agent or a blend of flavouring agents, preferably between 1% and 2% wt of a single flavouring agent or a blend of flavouring agents.

Example Ex39: An aerosol-generating article according to Ex38, wherein the flavouring agent(s) comprise one or more of a complex volatile oil, anise oil, aldehyde, vanillin, ginger oil, peppermint oil, lemongrass oil, tobacco extract oil, menthol oil, or combinations thereof.

Example Ex40: An aerosol-generating article according to any one of Ex0a to Ex39, comprising a plurality of portions of sensorial media, at least one of the portions of sensorial media having a different material composition to the other portions.

Example Ex41: An aerosol-generating article according to any one of Ex0a to Ex40, comprising a plurality of portions of sensorial media, the plurality of portions successively arranged along a length direction of the first sheet, optionally wherein the length direction also corresponds to a length direction of the aerosol-generating article.

Example Ex42: An aerosol-generating article according to Ex41, wherein each of the portions is spatially separated from the other portions.

Example Ex43: An aerosol-generating article according to any one of Ex0a to Ex42, the aerosol-generating article having a length, a width and a thickness, wherein the ratio of the width to the thickness is greater than 5, or greater than 10, or greater than 20, or greater than 40.

Example Ex44: An aerosol-generating article according to any one of Ex0a to Ex43, the aerosol-generating article having a length, a width and a thickness, wherein the thickness is 1 millimetre or less, or 0.75 millimetres or less, or 0.5 millimetres or less.

Example Ex45: An aerosol-generating article according to Ex44, wherein the thickness is greater than 0.05 millimetres, or greater than 0.1 millimetres.

Example Ex46: An aerosol-generating article according to any one of Ex43 to Ex45, wherein the length is greater than 15 millimetres, or preferably in a range of between 15 millimetres and 100 millimetres, or preferably in a range of between 15 millimetres and 75 millimetres, or preferably in a range of between 15 millimetres and 65 millimetres, or preferably in a range of between 20 millimetres and 65 millimetres, or preferably in a range of between 28 millimetres and 62 millimetres, or preferably in a range of between 28 millimetres and 48 millimetres, or preferably in a range of between 35 millimetres and 48 millimetres.

Example Ex47: An aerosol-generating article according to any one of Ex43 to Ex46, wherein the width is greater than 5 millimetres, or preferably in a range of between 5 millimetres and 40 millimetres, or preferably in a range of between 5 millimetres and 31 millimetres, or preferably in a range of between 8 millimetres and 31 millimetres, or preferably in a range of between 11 millimetres and 25 millimetres.

Example Ex48: An aerosol-generating article according to any one of Ex0a to Ex47, wherein the aerosol-generating article is generally flat.

Example Ex49: An aerosol-generating article according to Ex48, wherein the aerosol-generating article has a thickness defined by a separation between opposing first and second major surfaces of the aerosol-generating article, the opposing major surfaces each being planar.

Example Ex50: An aerosol-generating article according to Ex49, wherein an outward-facing surface of the first sheet defines the first major surface and an outward-facing surface of the second sheet (when present) defines the second major surface.

Example Ex51: An aerosol-generating article according to any one of Ex0a to Ex50, wherein the aerosol-generating article defines a generally parallelepiped profile.

Example Ex52: An aerosol-generating article according to any one of Ex0a to Ex51, wherein the aerosol-generating article is generally rectangular in plan.

Example Ex53: An aerosol-generating article according to any one of Ex0a to Ex52, wherein the first sheet is generally rectangular in plan.

Example Ex54: An aerosol-generating article according to Ex53, wherein the second sheet (when present) is generally rectangular in plan.

Example Ex55: An aerosol-generating article according to any one of Ex0a to Ex54, wherein the first sheet is generally planar.

Example Ex56: An aerosol-generating article according to Ex55, wherein the second sheet (when present) is generally planar.

Example Ex57: An aerosol-generating article for use with an aerosol-generating device, for example an aerosol-generating article according to any one of Ex0a to Ex56, the aerosol-generating article comprising:
a frame comprising opposed first and second surfaces and a cavity, the opposed first and second surfaces defining a thickness of the frame, the frame enclosing the cavity, the cavity extending through the thickness of the frame;
a first sheet fixed to the first surface of the frame to overlie the cavity;
a portion of sensorial media disposed directly on the first sheet within the cavity;
wherein the second surface of the frame is peelably attachable to an impermeable surface of an element to thereby close the cavity and seal the portion of sensorial media within the cavity.

Example Ex57a: An aerosol-generating article according to Ex57, the aerosol-generating article having opposed first and second outward-facing planar surfaces, optionally the first and second outward-facing surfaces being parallel to each other.

Example Ex57b: An aerosol-generating article according to Ex57a, wherein a separation between the first and second outward-facing planar surfaces defines a thickness of the aerosol-generating article.

Example Ex57c: An aerosol-generating article according to either one of Ex57a or Ex57b, wherein the first outward-facing planar surface is an outward-facing surface of the first sheet.

Example Ex57d: An aerosol-generating article according to Ex57c, wherein the second outward-facing planar surface is the second surface of the frame.

Example Ex58: An aerosol-generating article according to any one of Ex57 to Ex57d, wherein the fixation of the first sheet to the first surface of the frame is configured to define a hermetic seal therebetween.

Example Ex59: An aerosol-generating article according to any one of Ex57 to Ex58, wherein the peelable attachment of the second surface of the frame to the impermeable surface of the element is configured to define a hermetic seal therebetween.

Example Ex60: An aerosol-generating article according to any one of Ex57 to Ex59, wherein a separation distance between an outward-facing surface of the first sheet and the second surface of the frame defines a thickness of the aerosol-generating article.

Example Ex61: An aerosol-generating article according to any one of Ex57 to Ex60, wherein the element is a peelable lid, the aerosol-generating article comprising the peelable lid.

Example Ex62: An aerosol-generating article according to Ex61, wherein a separation distance between respective outward-facing surfaces of the first sheet and the peelable lid defines a thickness of the aerosol-generating article.

Example Ex63: An aerosol-generating article according to either one of Ex61 or Ex62, wherein one or both of the second surface of the frame and the impermeable surface of the peelable lid comprise or are overlaid with an adhesive, the adhesive configured to provide the peelable attachment between the second surface of the frame and the peelable lid.

Example Ex64: An aerosol-generating article according to any one of Ex61 to Ex63, wherein the peelable lid is free of adhesive in all locations corresponding to where the peelable lid overlies the cavity.

Example Ex65: An aerosol-generating article according to Ex64, wherein the adhesive is provided as a layer of the peelable lid.

Example Ex66: An aerosol-generating article according to any one of Ex61 to Ex65, wherein the peelable lid is formed as a peelable foil.

Example Ex67: An aerosol-generating article according to Ex66, wherein the peelable foil comprises aluminium.

Example Ex68: An aerosol-generating article according to any one of Ex57 to Ex60, wherein the element is:
a sheet configured for the peelable attachment thereto of two or more of the aerosol-generating articles; or
a wall of a packaging container, the wall configured for the peelable attachment thereto of two or more of the aerosol-generating articles.

Example Ex69: An aerosol-generating article according to any one of Ex57 to Ex68, wherein the first sheet comprises or consists of a material having a thermal conductivity of at least 10 W/mK.

Example Ex70: An aerosol-generating article according to Ex69, wherein the material is a metallic material.

Example Ex71: An aerosol-generating article according to Ex70, wherein the metallic material comprises or consists of aluminium.

Example Ex72: An aerosol-generating article according to any one of Ex57 to Ex71, wherein the first sheet and the impermeable surface of the element are each configured to be water impermeable.

Example Ex73: An aerosol-generating article according to any one of Ex57 to Ex72, wherein one or both of the first sheet and the impermeable surface of the element has a permeability in a range of between 1 to 5 Coresta Units.

Example Ex74: An aerosol-generating article according to any one of Ex57 to Ex73, wherein the first sheet comprises a layer of thermally conductive material.

Example Ex75: An aerosol-generating article according to Ex74, wherein the layer of thermally conductive material comprises or consists of aluminium.

Example Ex76: An aerosol-generating article according to either one of Ex74 or Ex75, wherein the layer of thermally conductive material forms an impermeable surface of the first sheet on which the portion of sensorial media is directly disposed.

Example Ex77: An aerosol-generating article according to any one of Ex74 to Ex76, wherein the first sheet comprises a laminate of the layer of thermally conductive material and at least one additional layer.

Example Ex78: An aerosol-generating article according to Ex77, wherein the at least one additional layer comprises a layer of a cellulose-based material or a paper-based material.

Example Ex79: An aerosol-generating article according to either one of Ex77 or Ex78, wherein the at least one additional layer comprises a layer of an impermeable material.

Example Ex80: An aerosol-generating article according to Ex79, wherein the layer of impermeable material has a thickness in a range of between 0.75 and 1.5 microns.

Example Ex81: An aerosol-generating article according to either one of Ex79 or Ex80, wherein the layer of impermeable material forms an impermeable surface of the first sheet on which the portion of sensorial media is directly disposed.

Example Ex82: An aerosol-generating article according to any one of Ex57 to Ex81, wherein the first sheet has a thickness in a range of between 0.07 millimetres and 0.75 millimetres, preferably between 0.10 millimetres and 0.35 millimetres, preferably wherein the first sheet comprises a layer of paper-based material.

Example Ex82a: An aerosol-generating article according to any one of Ex57 to Ex81, wherein the first sheet has a thickness in a range of between 0.5 and 100 microns, or optionally between 0.5 and 75 microns, or optionally between 0.5 and 50 microns, or optionally between 0.5 and 25 microns, or optionally between 0.5 and 10 microns, or optionally between 0.5 and 5 microns, or optionally between 1.1 and 4.5 microns, or optionally between 1.1 and 3 microns, or optionally between 1.1 and 2 microns, preferably wherein the first sheet lacks a layer of paper-based material.

Example Ex83: An aerosol-generating article according to any one of Ex57 to Ex82a, wherein the first sheet has a basis weight in a range of between 45 and 140 grammes per metre, optionally between 50 and 110 grammes per metre.

Example Ex84: An aerosol-generating article according to any one of Ex57 to Ex83, wherein the frame comprises a paper-based material.

Example Ex85: An aerosol-generating article according to Ex84, wherein the frame has a basis weight of between 200 and 500 grammes per metre, optionally between 250 and 400 grammes per metre.

Example Ex86: An aerosol-generating article according to any one of Ex57 to Ex85, wherein the frame is configured to be water impermeable Example Ex87: An aerosol-generating article according to any one of Ex57 to Ex86, wherein the frame has a permeability in a range of between 1 and 3 Coresta units.

Example Ex88: An aerosol-generating article according to any one of Ex57 to Ex87, wherein the frame encloses a single cavity.

Example Ex89: An aerosol-generating article according to Ex88, wherein a single portion of sensorial media is arranged within the single cavity.

Example Ex90: An aerosol-generating article according to Ex88, wherein a plurality of portions of sensorial media are arranged within the single cavity.

Example Ex91: An aerosol-generating article according to Ex90, wherein the plurality of portions of sensorial media are successively arranged along a length direction of the first frame within the single cavity.

Example Ex92: An aerosol-generating article according to either one of Ex90 or Ex91, wherein each one of the plurality of portions of sensorial media is spatially separated from the other portions within the single cavity.

Example Ex93: An aerosol-generating article according to any one of Ex88 to Ex92, wherein the frame comprises an airflow inlet and an airflow outlet, the airflow inlet and airflow outlet in fluid communication with the single cavity to permit a flow of air between the airflow inlet and airflow outlet to pass over the sensorial media.

Example Ex94: An aerosol-generating article according to any one of Ex57 to Ex87, wherein the frame encloses a plurality of cavities, the frame separately enclosing each one of the plurality of cavities.

Example Ex95: An aerosol-generating article according to Ex94, wherein fixation of the first sheet to the first surface of the frame and the peelable attachment of the second surface of the frame to the impermeable surface of the element are both configured to seal each one of the plurality of cavities from each other.

Example Ex96: An aerosol-generating article according to either one of Ex94 or Ex95, comprising a plurality of portions of sensorial media, each one of the plurality of cavities containing at least one of the plurality of portions of sensorial media.

Example Ex97: An aerosol-generating article according to Ex96, wherein each one of the plurality of cavities contains a single one of the plurality of portions of sensorial media.

Example Ex98: An aerosol-generating article according to any one of Ex94 to Ex97, wherein the frame comprises an airflow inlet and an airflow outlet for each one of the plurality of cavities, the airflow inlet and airflow outlet configured to permit a flow of air between the airflow inlet and airflow outlet of the respective cavity to pass over the sensorial media contained in the respective cavity.

Example Ex99: An aerosol-generating article according to Ex98, wherein the frame comprises a common airflow inlet channel, each of the airflow inlets in fluid communication with the common airflow inlet channel.

Example Ex100: An aerosol-generating article according to either one of Ex98 or Ex99, wherein the frame comprises a common airflow outlet channel, each of the airflow outlets in fluid communication with the common airflow outlet channel.

Example Ex101: An aerosol-generating article according to Ex100, wherein the common airflow outlet channel comprises a mixing chamber for mixing of the airflows received from each of the plurality of cavities via the respective airflow outlets.

Example Ex102: An aerosol-generating article according to any one of Ex57 to Ex101, wherein the sensorial media comprises any one or more of tobacco, nicotine, botanicals, cannabinoid, and a flavouring agent.

Example Ex103: An aerosol-generating article according to Ex102, wherein the sensorial media comprises or consists of homogenised tobacco.

Example Ex104: An aerosol-generating article according to Ex103, wherein the sensorial media comprises homogenised tobacco and an aerosol former.

Example Ex105: An aerosol-generating article according to any one of Ex57 to Ex104, wherein the portion of sensorial media has a gel composition, optionally the gel composition comprises nicotine.

Example Ex106: An aerosol-generating article according to Ex105, wherein the gel composition comprises between 1% and 3% wt nicotine.

Example Ex107: An aerosol-generating article according to either one of Ex105 or Ex106, wherein the gel composition comprises between 80% and 90% wt glycerol, and a total weight of water and glycerol in a range of between 85% and 95% wt.

Example Ex108: An aerosol-generating article according to any one of Ex105 to Ex107, wherein the gel composition comprises between 2% and 7% wt of a gelling agent.

Example Ex109: An aerosol-generating article according to any one of Ex105 to Ex108, wherein the gel composition comprises between 1% and 4% wt of a single flavouring agent or a blend of flavouring agents, preferably between 1% and 2% wt of a single flavouring agent or a blend of flavouring agents.

Example Ex110: An aerosol-generating article according to Ex109, wherein the flavouring agent(s) comprise one or more of a complex volatile oil, anise oil, aldehyde, vanillin, ginger oil, peppermint oil, lemongrass oil, tobacco extract oil, menthol oil, or combinations thereof.

Example Ex111: An aerosol-generating article according to any one of Ex57 to Ex110, comprising a plurality of portions of sensorial media, at least one of the portions of sensorial media having a different material composition to the other portions.

Example Ex112: An aerosol-generating article according to any one of Ex57 to Ex111, the aerosol-generating article having a length, a width and a thickness, wherein the ratio of the width to the thickness is greater than 5, or greater than 10, or greater than 20, or greater than 40.

Example Ex113: An aerosol-generating article according to any one of Ex57 to Ex112, the aerosol-generating article having a length, a width and a thickness, wherein the thickness is 6 millimetres or less, or preferably 5.5 millimetres or less, or preferably 3.5 millimetres or less, or preferably in a range of between 1.25 millimetres and 3.5 millimetres.

Example Ex114: An aerosol-generating article according to Ex113, wherein the thickness is greater than 0.5 millimetre, or preferably greater than 1 millimetre.

Example Ex115: An aerosol-generating article according to any one of Ex112 to Ex114, wherein the length is greater than 15 millimetres, or preferably in a range of between 15 millimetres and 100 millimetres, or preferably in a range of between 15 millimetres and 75 millimetres, or preferably in a range of between 15 millimetres and 65 millimetres, or preferably in a range of between 20 millimetres and 65 millimetres, or preferably in a range of between 28 millimetres and 62 millimetres, or preferably in a range of between 28 millimetres and 48 millimetres, or preferably in a range of between 35 millimetres and 48 millimetres.

Example Ex116: An aerosol-generating article according to any one of Ex112 to Ex115, wherein the width is greater than 5 millimetres, or preferably in a range of between 5 millimetres and 40 millimetres, or preferably in a range of between 5 millimetres and 31 millimetres, or preferably in a range of between 8 millimetres and 31 millimetres, or preferably in a range of between 11 millimetres and 25 millimetres.

Example Ex117: An aerosol-generating article according to any one of Ex57 to Ex116, wherein the aerosol-generating article is generally flat.

Example Ex118: An aerosol-generating article according to any one of Ex57 to Ex117, wherein the aerosol-generating article defines a generally parallelepiped profile.

Example Ex119: An aerosol-generating article according to any one of Ex57 to Ex118, wherein the aerosol-generating article is generally rectangular in plan.

Example Ex120: An aerosol-generating article according to any one of Ex57 to Ex119, wherein the first sheet is generally rectangular in plan.

Example Ex121: An aerosol-generating article according to Ex120, wherein the peelable lid (when present) is generally rectangular in plan.

Example Ex122: An aerosol-generating article according to any one of Ex57 to Ex121, wherein the frame is generally rectangular in plan.

Example Ex123: An aerosol-generating article according to any one of Ex57 to Ex122, wherein the first sheet is generally planar.

Example Ex124: An aerosol-generating article according to any one of Ex57 to Ex123, wherein the opposed first and second surfaces of the frame are generally planar.

Example Ex125: An assembly comprising a plurality of aerosol-generating articles and a supporting sheet, wherein the plurality of aerosol-generating articles are peelably attached to an impermeable surface of the supporting sheet;
each of the aerosol-generating articles comprising:
   a frame comprising opposed first and second surfaces and a cavity, the opposed first and second surfaces defining a thickness of the frame, the frame enclosing the cavity, the cavity extending through the thickness of the frame;
   a first sheet, the first sheet fixed to the first surface of the frame to overlie the cavity;
   a portion of sensorial media disposed directly on the impermeable surface of the first sheet within the cavity;
wherein for each of the aerosol-generating articles, the second surface of the frame is peelably attached to the impermeable surface of the supporting sheet to thereby close the cavity and seal the portion of sensorial media within the cavity.

Example Ex126: An assembly according to Ex125, wherein the first sheet comprises a tab for a user to engage therewith to thereby peel the respective aerosol-generating article away from the supporting sheet.

Example Ex127: An assembly according to either one of Ex125 or Ex126, wherein the plurality of aerosol-generating articles are peelably attached to the impermeable surface of the supporting sheet to define an arrangement of one or more rows or columns.

Example Ex128: An assembly according to any one of Ex125 to Ex127, wherein the supporting sheet comprises a first portion and a second portion separated from each other by a fold line, each of the plurality of aerosol-generating articles peelably attached to the first portion of the supporting sheet, the second portion folded about the fold line to at least partially overlie the plurality of aerosol-generating articles.

Example Ex129: An assembly according to any one of Ex125 to Ex128, wherein the assembly further comprises a packaging container, the supporting sheet to which the plurality of aerosol-generating articles are peelably attached inserted inside the packaging container.

Example Ex130: An assembly comprising a plurality of aerosol-generating articles and a packaging container;
each of the aerosol-generating articles comprising:
   a frame comprising opposed first and second surfaces and a cavity, the opposed first and second surfaces defining a thickness of the frame, the frame enclosing the cavity, the cavity extending through the thickness of the frame;
   a first sheet fixed to the first surface of the frame to overlie the cavity;
   a portion of sensorial media disposed directly on the impermeable surface of the first sheet within cavity;
the packaging container comprising a wall having an impermeable surface;
   wherein for each of the aerosol-generating articles, the second surface of the frame is peelably attached to the impermeable surface of the wall of the packaging container to thereby close the cavity and seal the portion of sensorial media within the cavity.

Example Ex131: An assembly according to Ex130, wherein the first sheet comprises a tab for a user to engage therewith to thereby peel the respective aerosol-generating article away from the wall of the packaging container.

Example Ex132: An assembly according to either one of Ex130 or Ex131, wherein the impermeable surface of the wall defines an interior surface of the packaging container.

Example Ex133: An assembly according to either one of Ex130 or Ex131, wherein the impermeable surface of the wall defines an exterior surface of the packaging container.

Example Ex134: A packaging assembly comprising:
a container comprising first and second planar wall portions, the first planar wall portion comprising an attachment surface; and
an aerosol-generating article, for example an aerosol-generating article according to any one of Ex0a to Ex133, the aerosol-generating article comprising opposed first and second outward facing surfaces, and a portion of sensorial media contained within the aerosol-generating article, the portion of sensorial media in fluid communication with an opening defined in the second outward facing surface of the aerosol-generating article, the second outward-facing surface of the aerosol-generating article releasably attached to the attachment surface of the first planar wall portion of the container to thereby close and seal the opening;
wherein the first and second planar wall portions are separated by a first fold region, the second planar wall portion foldable about the first fold region between a closed position and an open position, wherein in the closed position the second planar wall portion covers at least part of the first outward-facing surface of the aerosol-generating article.

Example Ex135: A packaging assembly according to Ex134, wherein a separation between the first and second outward-facing surfaces of the aerosol-generating article defines a thickness of the aerosol-generating article.

Example Ex136: A packaging assembly according to either one of Ex134 or Ex135, wherein the first and second planar wall portions are integrally formed as a single unitary sheet.

Example Ex137: A packaging assembly according to any one of Ex134 to Ex136, wherein the container comprises a frangible interface for retaining the second planar wall portion in the closed position.

Example Ex138: A packaging assembly according to Ex137, wherein the frangible interface is provided between the first and second planar wall portions.

Example Ex139: A packaging assembly according to any one of Ex134 to Ex138, wherein the container comprises a third planar wall portion, the first and third planar wall portions separated by a second fold region, the third planar sheet portion foldable about the second fold region between a closed position and an open position, wherein in the closed position of the second and third planar sheet portions, one of the second and third planar sheet portions overlies the other of the second and third planar wall portions.

Example Ex140: A packaging assembly according to Ex139, wherein the first, second and third planar wall portions are integrally formed as a single unitary sheet.

Example Ex141: A packaging assembly according to either one of Ex139 or Ex140, wherein in the closed position of the second and third planar wall portions, the second and third planar wall portions in combination cover all of the first outward-facing surface of the aerosol-generating article.

Example Ex142: A packaging assembly according to any one of Ex139 to Ex141, wherein the first and second fold regions are positioned at opposite ends of the first planar wall portion.

Example Ex143: A packaging assembly according to any one of Ex139 to Ex142, wherein the container comprises a frangible interface for retaining the third planar wall portion in the closed position.

Example Ex144: A packaging assembly according to Ex143, wherein the frangible interface is provided between the second and third planar wall portions.

Example Ex145: A packaging assembly according to any one of Ex139 to Ex144, wherein in the closed position of the second and third planar wall portions, opposing surfaces of the second and third planar wall portions are adhered to each other.

Example Ex146: A packaging assembly according to Ex145, wherein the second and third planar wall portions are adhered to each other in the closed position by one or more portions of adhesive, the one or more portions of adhesive comprising or consisting of a low-tack adhesive.

Example Ex147: A packaging assembly according to Ex146, wherein the low-tack adhesive comprises a base of acrylate copolymer microspheres, optionally the low-tack adhesive further comprising one or more of aluminum powder, amorphous silica, sodium carbonate, sodium chromate, and polyaminoamide.

Example Ex148: A packaging assembly according to any one of Ex134 to Ex147, wherein any one or all of the first planar wall portion, the second planar wall portion and (where present) the third planar wall portion comprise a paper-based substrate.

Example Ex149: A packaging assembly according to Ex148, wherein any one or all of the first planar wall portion, the second planar wall portion and (where present) the third planar wall portion have a basis weight of between 180 and 450 grammes per metre, optionally between 200 and 300 grammes per metre.

Example Ex150: A packaging assembly according to either one of Ex148 or Ex149, wherein the first planar wall portion and optionally the second planar wall portion have a thickness in a range of between 0.35 and 2.5 millimetres.

Example Ex151: A packaging assembly according to any one of Ex134 to Ex150, wherein the first planar wall portion has a permeability in a range of between 1 and 10 Coresta units.

Example Ex152: A packaging assembly according to any one of Ex134 to Ex151, wherein the attachment surface is configured as an impermeable surface.

Example Ex153: A packaging assembly according to Ex152, wherein the attachment surface is configured to be water impermeable.

Example Ex154: A packaging assembly according to either one of Ex152 or Ex153, wherein the first planar wall portion comprises an impermeable layer, the impermeable layer defining the attachment surface.

Example Ex155: A packaging assembly according to Ex154 in combination with Ex148, wherein the impermeable layer overlies the paper-based substrate.

Example Ex156: A packaging assembly according to either one of Ex154 or Ex155, wherein the impermeable layer has a thickness in a range of between 0.75 and 1.5 microns.

Example Ex157: A packaging assembly according to any one of Ex134 to Ex156, wherein the releasable attachment of the second outward-facing surface of the aerosol-generating article to the attachment surface of the first planar wall portion of the container is configured to define a hermetic seal therebetween.

Example Ex158: A packaging assembly according to any one of Ex134 to Ex157, wherein the releasable attachment of the second outward-facing surface of the aerosol-generating article to the attachment surface of the first planar wall portion of the container is configured as a peelable attachment.

Example Ex159: A packaging assembly according to Ex158, wherein the aerosol-generating article comprises a tab for a user to engage therewith to thereby peel the aerosol-generating article away from the attachment surface of the first planar wall portion of the container.

Example Ex160: A packaging assembly according to any one of Ex133 to Ex159, wherein a plurality of the aerosol-generating articles are peelably attached to the attachment surface of the first planar wall portion to define an arrangement of one or more rows or columns.

Example Ex161: A packaging assembly according to any one of Ex134 to Ex160, wherein the aerosol-generating article comprises:
a frame comprising opposed first and second surfaces and a cavity, the opposed first and second surfaces defining a thickness of the frame, the frame enclosing a cavity, the cavity extending through the thickness of the frame to define the opening, the portion of sensorial media disposed within the cavity, the second surface of the frame defining the second outward-facing surface of the aerosol-generating article and being peelably attached to the attachment surface.

Example Ex162: A packaging assembly according to Ex161, the aerosol-generating article further comprising a first sheet, the first sheet of the aerosol-generating article fixed to the first surface of the frame to overlie the cavity, wherein the first sheet defines the first outward-facing surface of the aerosol-generating article.

Example Ex163: A packaging assembly according to Ex162, the first sheet comprising a tab for a user to engage therewith to thereby peel the aerosol-generating article away from the attachment surface.

Example Ex164: A packaging assembly according to Ex163, wherein the fixation of the first sheet to the first surface of the frame is configured such that the first sheet remains fixed to the first surface of the frame if pulling on the tab to peel the aerosol-generating article away from the attachment surface.

Example Ex165: A packaging assembly according to any one of Ex162 to Ex164, wherein the fixation of the first sheet to the first surface of the frame is configured to define a hermetic seal therebetween.

Example Ex166: A packaging assembly according to any one of Ex162 to Ex165, wherein the first sheet is configured to be water impermeable.

Example Ex167: A packaging assembly according to any one of Ex162 to Ex166, wherein the first sheet has a permeability in a range of between 1 and 5 Coresta units.

Example Ex168: A packaging assembly according to any one of Ex162 to Ex167, wherein the first sheet comprises a layer of thermally conductive material.

Example Ex169: A packaging assembly according to Ex168, wherein the layer of thermally conductive material comprises or consists of aluminium.

Example Ex170: A packaging assembly according to either one of Ex168 or Ex169, wherein the first sheet comprises a laminate of the layer of thermally conductive material and at least one additional layer.

Example Ex171: A packaging assembly according to Ex170, wherein the at least one additional layer comprises a layer of a cellulose-based material or a paper-based material.

Example Ex172: A packaging assembly according to either one of Ex170 or Ex171, wherein the at least one additional layer comprises a layer of an impermeable material, optionally wherein the layer of impermeable material has a thickness in a range of between 0.75 and 1.5 microns.

Example Ex173: An aerosol-generating article according to any one of Ex162 to Ex172, wherein the first sheet has a thickness in a range of between 0.07 millimetres and 0.75 millimetres, preferably between 0.10 millimetres and 0.35 millimetres, preferably wherein the first sheet comprises a layer of paper-based material.

Example Ex173a: A packaging assembly according to any one of Ex162 to Ex172, wherein the first sheet has a thickness in a range of between 0.5 and 100 microns, or optionally between 0.5 and 75 microns, or optionally between 0.5 and 50 microns, or optionally between 0.5 and 25 microns, or optionally between 0.5 and 10 microns, or optionally between 0.5 and 5 microns, or optionally between 1.1 and 4.5 microns, or optionally between 1.1 and 3 microns, or optionally between 1.1 and 2 microns, preferably wherein the first sheet lacks a layer of paper-based material.

Example Ex174: A packaging assembly according to any one of Ex162 to Ex173a, wherein the first sheet has a basis weight in a range of between 45 and 140 grammes per metre, optionally between 50 and 110 grammes per metre.

Example Ex175: A packaging assembly according to any one of Ex162 to Ex174, wherein a separation distance between an outward-facing surface of the first sheet and the second surface of the frame defines a thickness of the aerosol-generating article.

Example Ex176: A packaging assembly according to any one of Ex161 to Ex175, wherein the frame comprises a paper-based material.

Example Ex177: A packaging assembly according to Ex176, wherein the frame has a basis weight of between 200 and 500 grammes per metre, optionally between 250 and 400 grammes per metre.

Example Ex178: A packaging assembly according to any one of Ex161 to Ex177, wherein the frame is configured to be water impermeable.

Example Ex179: A packaging assembly according to any one of Ex161 to Ex178, wherein the frame has a permeability in a range of between 1 to 3 Coresta units.

Example Ex180: A packaging assembly according to any one of Ex161 to Ex179, wherein the frame encloses a single cavity.

Example Ex181: A packaging assembly according to Ex180, wherein a single portion of sensorial media is arranged within the single cavity.

Example Ex182: A packaging assembly according to Ex180, wherein a plurality of portions of sensorial media are arranged within the single cavity.

Example Ex183: A packaging assembly according to Ex182, wherein the plurality of portions of sensorial media are successively arranged along a length direction of the first frame within the single cavity.

Example Ex184: A packaging assembly according to either one of Ex182 or Ex183, wherein each one of the plurality of portions of sensorial media is spatially separated from the other portions.

Example Ex185: A packaging assembly according to any one of Ex161 to Ex179, wherein the frame encloses a plurality of cavities, the frame separately enclosing each one of the plurality of cavities.

Example Ex186: A packaging assembly according to Ex185, comprising a plurality of portions of sensorial media, each one of the plurality of cavities containing at least one of the plurality of portions of sensorial media.

Example Ex187: A packaging assembly according to Ex186, wherein each one of the plurality of cavities contains a single one of the plurality of portions of sensorial media.

Example Ex188: A packaging assembly according to any one of Ex134 to Ex187, wherein the sensorial media comprises any one or more of tobacco, nicotine, botanicals, cannabinoid, and a flavouring agent.

Example Ex189: A packaging assembly according to Ex188, wherein the sensorial media comprises or consists of homogenised tobacco.

Example Ex190: A packaging assembly according to Ex189, wherein the sensorial media comprises homogenised tobacco and an aerosol former.

Example Ex191: A packaging assembly according to any one of Ex134 to Ex190, wherein the portion of sensorial media has a gel composition, optionally the gel composition comprises nicotine.

Example Ex192: A packaging assembly according to Ex191, wherein the gel composition comprises between 1% to 3% wt nicotine.

Example Ex193: A packaging assembly according to either one of Ex191 or Ex192, wherein the gel composition comprises between 80% to 90% wt glycerol, and a total weight of water and glycerol in a range of between 85% to 95% wt.

Example Ex194: A packaging assembly according to any one of Ex191 to Ex193, wherein the gel composition comprises between 2% to 7% wt of a gelling agent.

Example Ex195: A packaging assembly according to any one of Ex191 to Ex194, wherein the gel composition comprises between 1% to 4% wt of a single flavouring agent or a blend of flavouring agents, preferably between 1% to 2% wt of a single flavouring agent or a blend of flavouring agents.

Example Ex196: A packaging assembly according to Ex195, wherein the flavouring agent(s) comprise one or more of a complex volatile oil, anise oil, aldehyde, vanillin, ginger oil, peppermint oil, lemongrass oil, tobacco extract oil, menthol oil, or combinations thereof.

Example Ex197: A packaging assembly according to any one of Ex134 to Ex196, comprising a plurality of portions of sensorial media, at least one of the portions of sensorial media having a different material composition to the other portions.

Example Ex198: A packaging assembly according to any one of Ex134 to Ex197, wherein the first and second planar wall portions and optionally the third wall planar wall portion (where present) are each rectangular in plan.

Example Ex199: A packaging assembly according to any one of Ex134 to Ex198, wherein in a closed state of the container the packaging assembly has a thickness, wherein the thickness is 20 millimetres or less, or preferably 15 millimetres or less, or preferably in a range of between 4 and 15 millimetres, or preferably in a range of between 6 and 13 millimetres.

Example Ex200: A packaging assembly according to any one of Ex134 to Ex199, wherein in a closed state of the container the packaging assembly has a length and a width; the length of the packaging assembly in a range of between 50 and 200 millimetres, or preferably in a range of between 50 and 180 millimetres, or preferably in a range of between 60 and 180 millimetres, or preferably in a range of between 80 and 150 millimetres; and the width of the packaging assembly in a range of between 35 and 120 millimetres, or preferably in a range of between 45 and 110 millimetres, or preferably in a range of between 50 and 95 millimetres.

Example Ex201: A packaging assembly according to any one of Ex134 to Ex200, wherein in a closed state of the container the packaging assembly is generally flat.

Example Ex202: A packaging assembly according to any one of Ex134 to Ex201, wherein the packaging assembly defines a generally parallelepiped profile.

Example Ex203: A packaging assembly according to any one of Ex134 to Ex202, wherein the packaging assembly is generally rectangular in plan.

Example Ex204: A packaging assembly according to any one of Ex134 to Ex203, the aerosol-generating article having a length, a width and a thickness, wherein the ratio of the width to the thickness is greater than 5, or greater than 10, or greater than 20, or greater than 40.

Example Ex205: A packaging assembly according to any one of Ex134 to Ex204, the aerosol-generating article having a length, a width and a thickness, wherein the thickness is 1 millimetre or less, or 0.75 millimetres or less, or 0.5 millimetres or less.

Example Ex206: A packaging assembly according to Ex205, wherein the thickness of the aerosol-generating article is greater than 0.05 millimetres, or greater than 0.1 millimetres.

Example Ex206: A packaging assembly according to any one of Ex204 to Ex206, wherein the length of the aerosol-generating article is greater than 15 millimetres, or preferably in a range of between 15 millimetres and 100 millimetres, or preferably in a range of between 15 millimetres and 75 millimetres, or preferably in a range of between 15 millimetres and 65 millimetres, or preferably in a range of between 20 millimetres and 65 millimetres, or preferably in a range of between 28 millimetres and 62 millimetres, or preferably in a range of between 28 millimetres and 48 millimetres, or preferably in a range of between 35 millimetres and 48 millimetres.

Example Ex207: A packaging assembly according to any one of Ex204 to Ex206, wherein the width of the aerosol-generating article is greater than 5 millimetres, or preferably in a range of between 5 millimetres and 40 millimetres, or preferably in a range of between 5 millimetres and 31 millimetres, or preferably in a range of between 8 millimetres and 31 millimetres, or preferably in a range of between 11 millimetres and 25 millimetres.

Example Ex208: A packaging assembly according to any one of Ex134 to Ex207, wherein the aerosol-generating article is generally flat.

Example Ex209: A packaging assembly according to any one of Ex134 to Ex208, wherein the aerosol-generating article defines a generally parallelepiped profile.

Example Ex210: A packaging assembly according to any one of Ex134 to Ex209, wherein the aerosol-generating article is generally rectangular in plan.

Example Ex211: A packaging assembly comprising:
a first planar wall portion, a planar surface of the first planar wall portion defining an attachment surface; and
an aerosol-generating article, for example an aerosol-generating article according to any one of Ex1 to Ex210, the aerosol-generating article comprising opposed first and second outward-facing surfaces and a portion of sensorial media contained within the aerosol-generating article, the portion of sensorial media in fluid communication with an opening defined in the second outward facing surface of the aerosol-generating article, the second outward-facing surface of the aerosol-generating article releasably attached to the attachment surface of the first planar wall portion to thereby close and seal the opening.

Example Ex212: A packaging assembly according to Ex211, further comprising: a container, the container comprising the first planar wall portion and a second planar wall portion, the first and second planar wall portions separated by a first fold region, the second planar wall portion foldable about the first fold region between a closed position and an open position, wherein in the closed position the second planar wall portion covers at least part of the first outward-facing surface of the aerosol-generating article.

The invention is further described, by way of example only, with reference to the accompanying drawings in which:

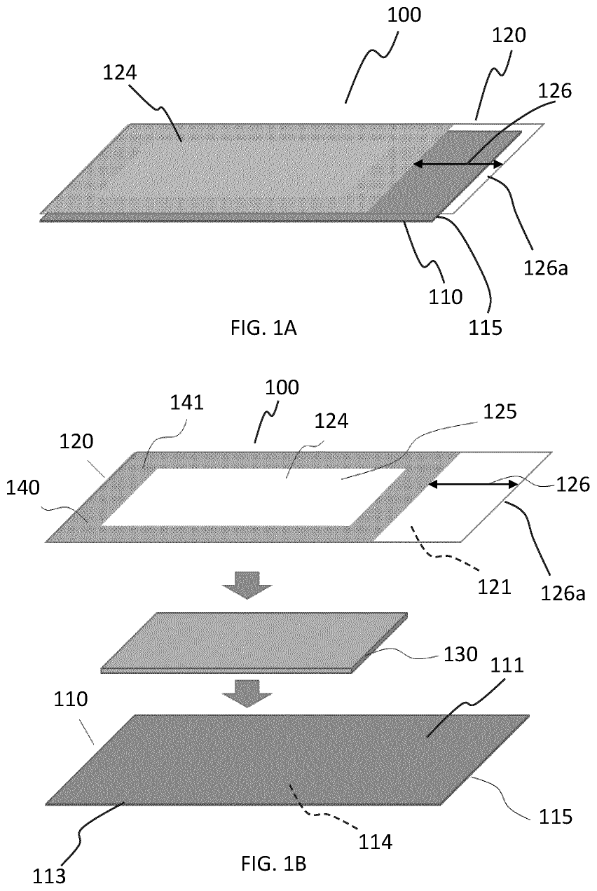

FIG. 1A is a schematic perspective view of an aerosol-generating article according to a first embodiment;

FIG. 1B is a schematic perspective exploded view showing the components of the aerosol-generating article of FIG. 1A;

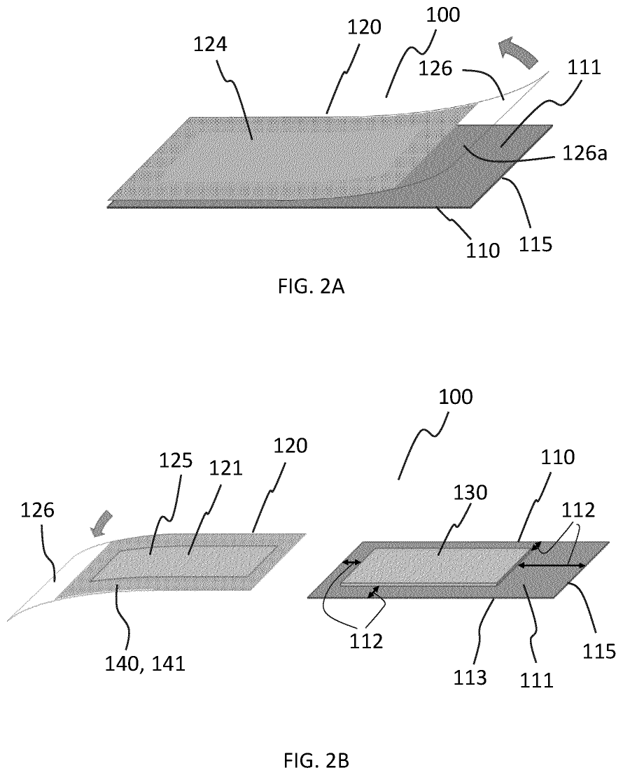

FIG. 2A is a schematic perspective of the aerosol-generating article of FIG. 1A during removal of a peelable sheet of the aerosol-generating article;

FIG. 2B is a schematic perspective view of the aerosol-generating article of FIG. 1A after detachment of the peelable sheet from the aerosol-generating article;

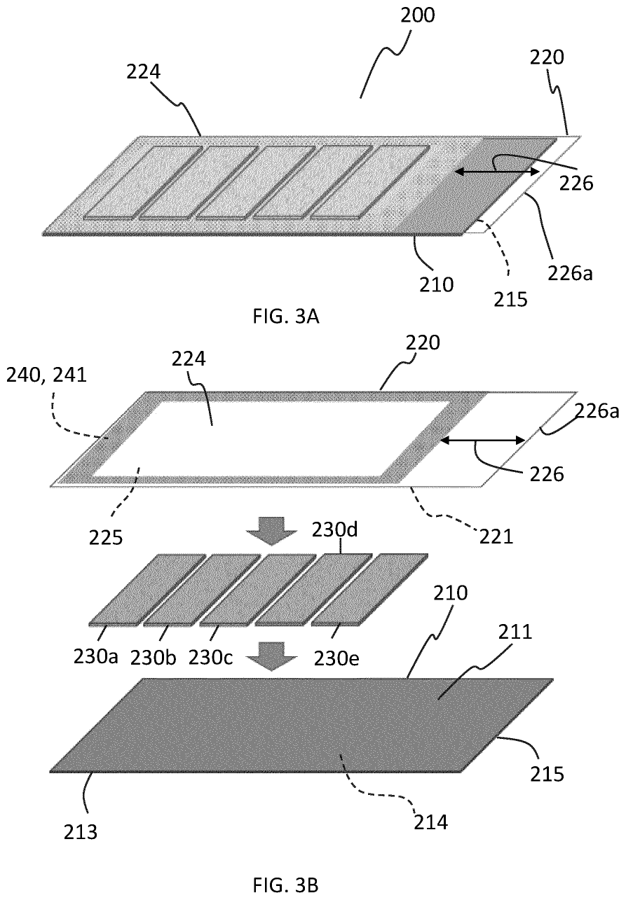

FIG. 3A is a schematic perspective view of an aerosol-generating article according to a second embodiment;

FIG. 3B is a schematic perspective exploded view showing the components of the aerosol-generating article of FIG. 3A;

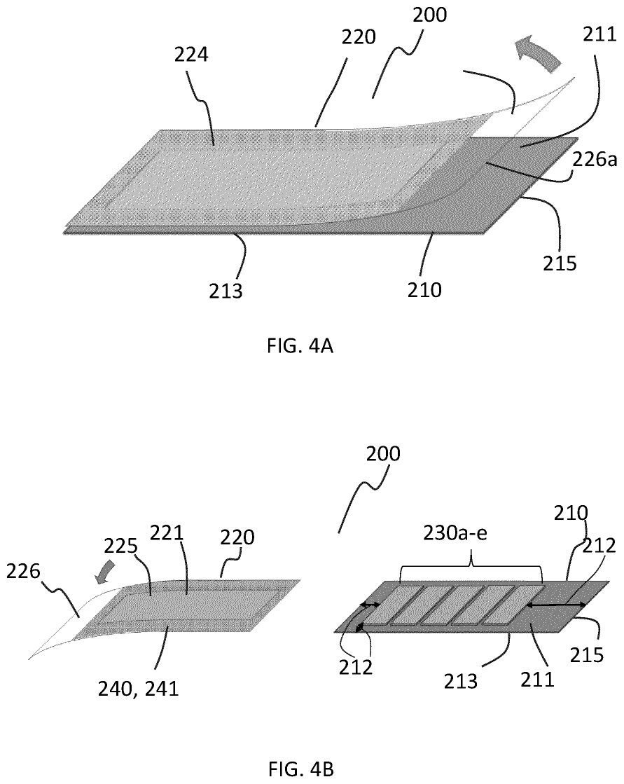

FIG. 4A is a schematic perspective of the aerosol-generating article of FIG. 3A during removal of a peelable sheet of the aerosol-generating article;

FIG. 4B is a schematic perspective view of the aerosol-generating article of FIG. 3A after detachment of the peelable sheet from the aerosol-generating article;

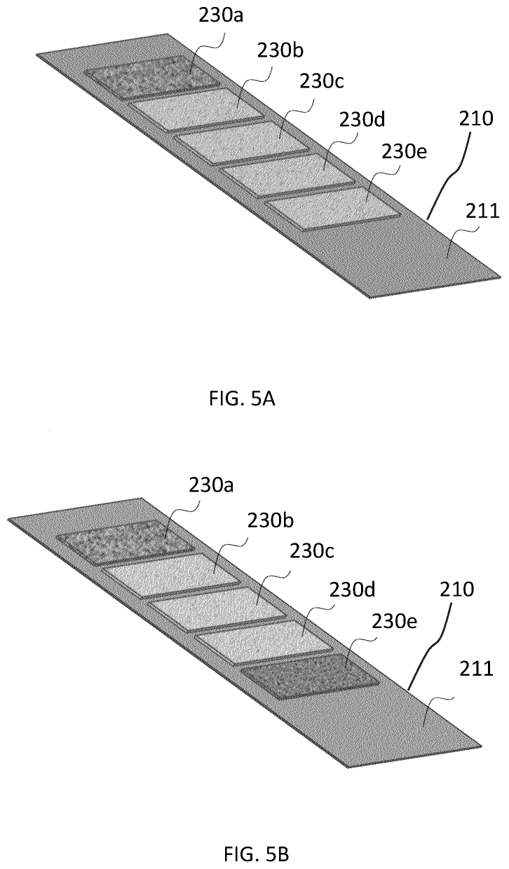

FIGS. 5A and 5B are schematic perspective views of two different embodiments of aerosol-generating article in which a plurality of portions of sensorial media are disposed directly on a sheet of the aerosol-generating article;

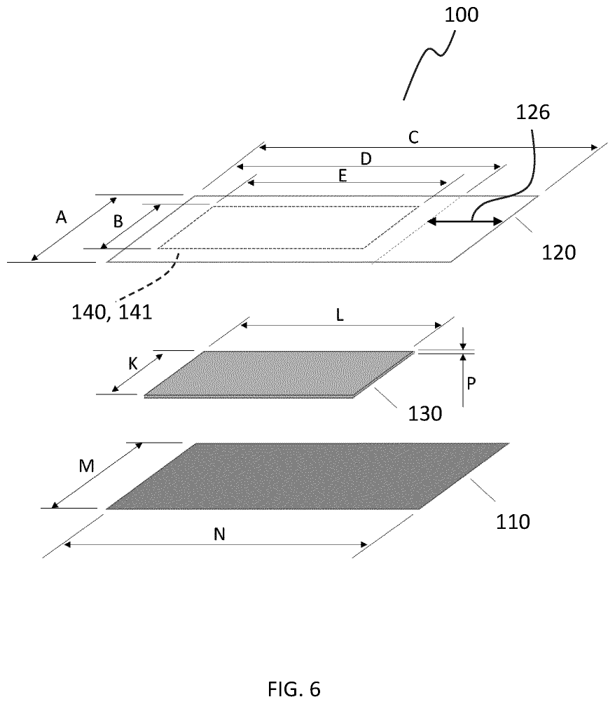

FIG. 6 is a schematic perspective view of the components of the aerosol-generating article of FIG. 1A, with different reference signs assigned to the different dimensions of the components;

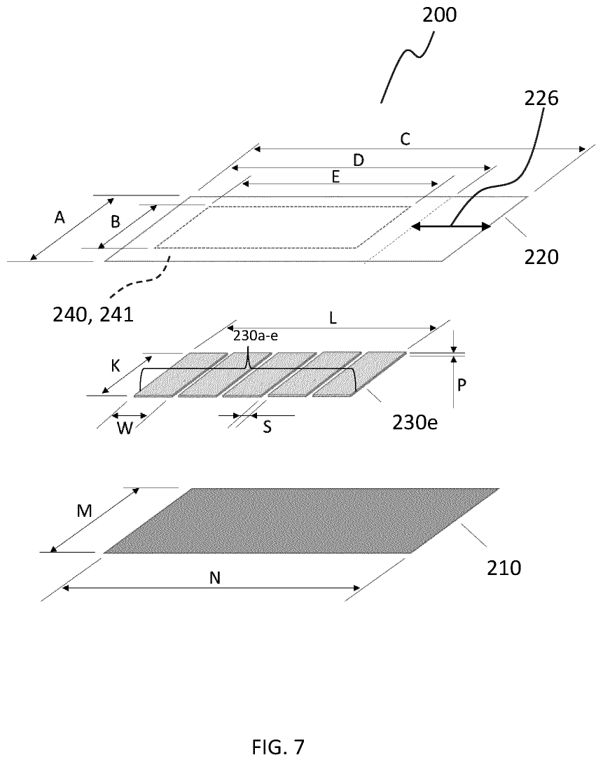

FIG. 7 is a schematic perspective view of the components of the aerosol-generating article of FIG. 3A, with different reference signs assigned to the different dimensions of the components;

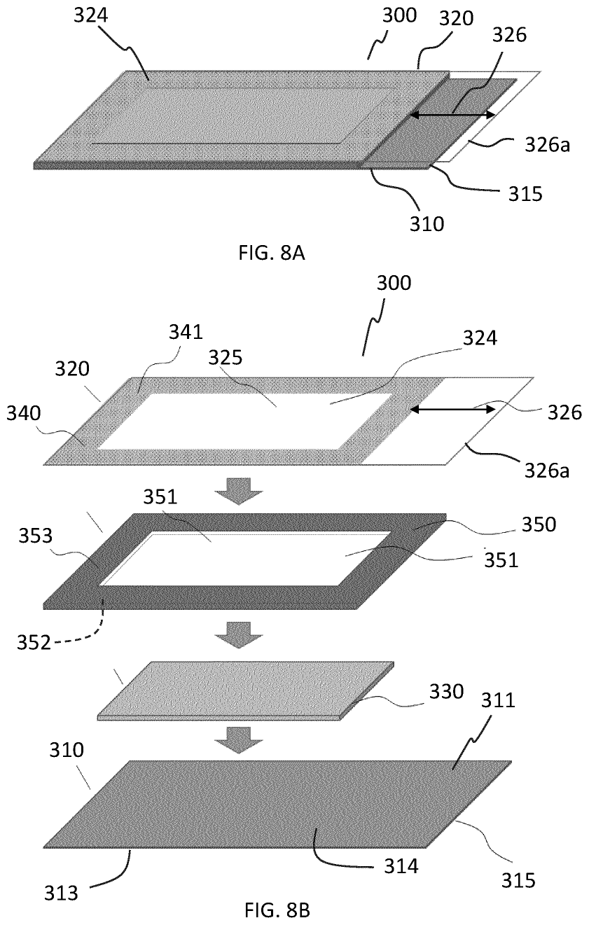

FIG. 8A is a schematic perspective view of an aerosol-generating article according to a third embodiment;

FIG. 8B is a schematic perspective exploded view showing the components of the aerosol-generating article of FIG. 8A;

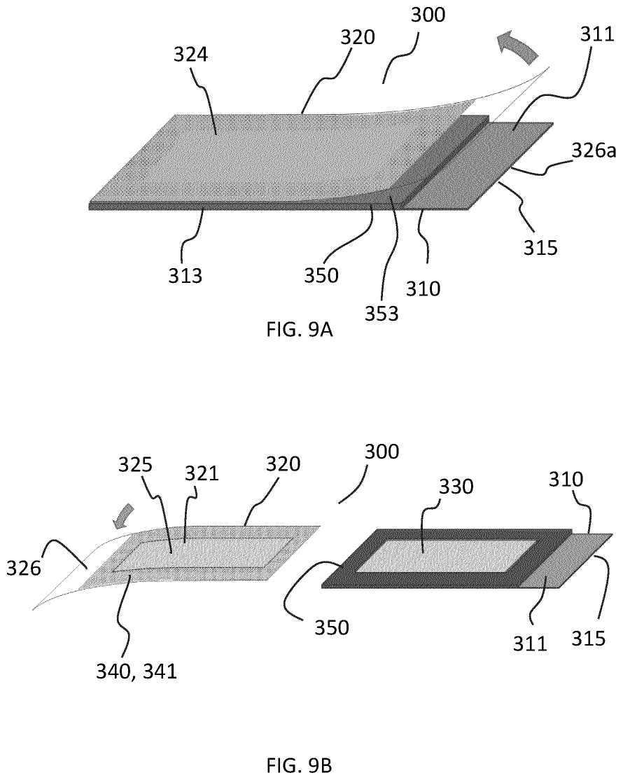

FIG. 9A is a schematic perspective view of the aerosol-generating article of FIG. 8A during removal of a peelable sheet from a frame of the aerosol-generating article;

FIG. 9B is a schematic perspective view of the aerosol-generating article of FIG. 8A after detachment of the peelable sheet from the frame of the aerosol-generating article;

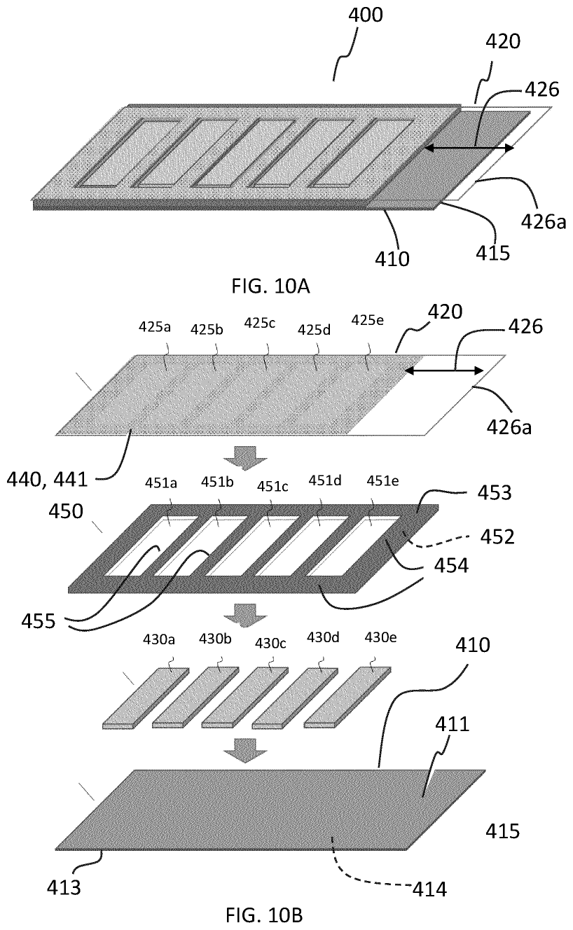

FIG. 10A is a schematic perspective view of an aerosol-generating article according to a fourth embodiment;

FIG. 10B is a schematic perspective exploded view showing the components of the aerosol-generating article of FIG. 10A;

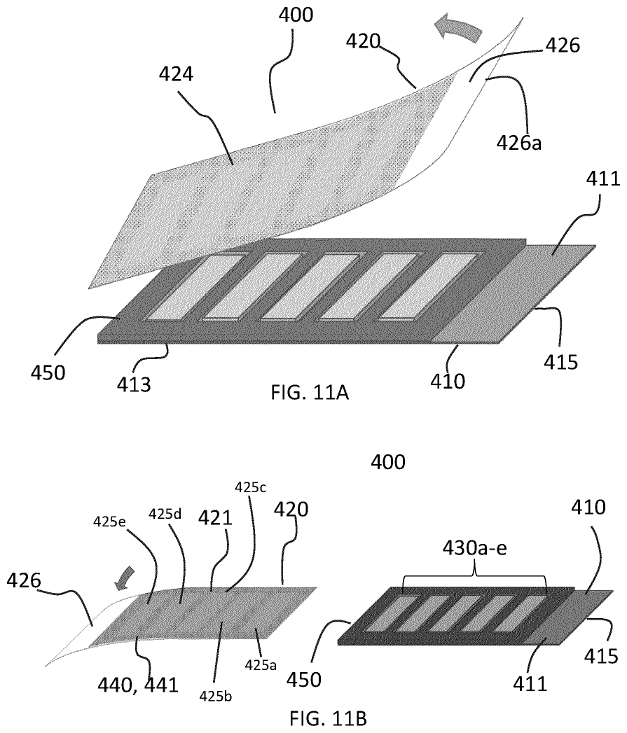

FIG. 11A is a schematic perspective of the aerosol-generating article of FIG. 10A during removal of a peelable sheet from a frame of the aerosol-generating article;

FIG. 11B is a schematic perspective view of the aerosol-generating article of FIG. 10A after detachment of the peelable sheet from the frame of the aerosol-generating article;

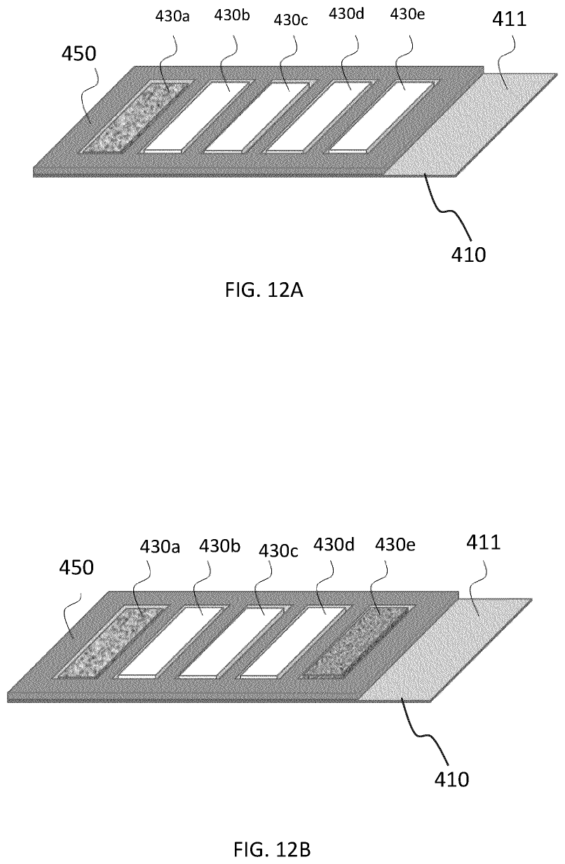

FIGS. 12A and 12B are schematic perspective views of two different embodiments of aerosol-generating article in which a plurality of portions of sensorial media are disposed directly on a sheet of the aerosol-generating article, each of the portions contained within respective cavities defined in a frame of the aerosol-generating article;

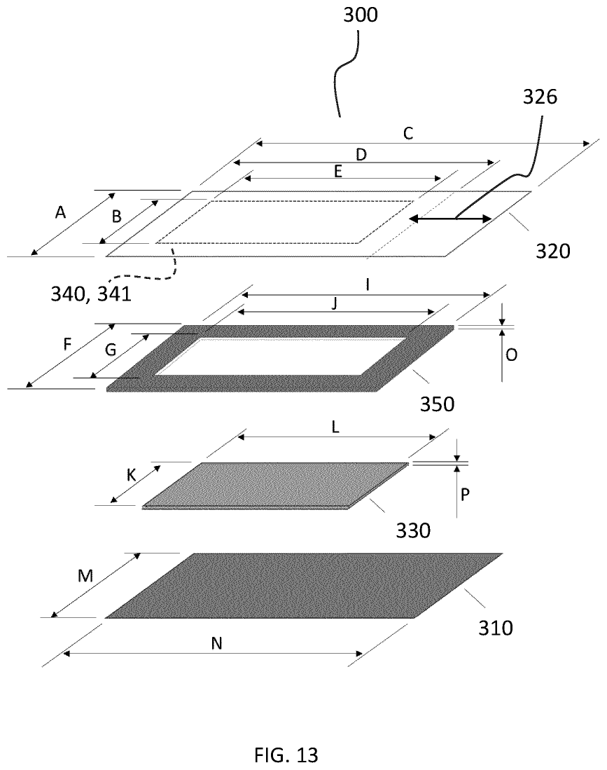

FIG. 13 is a schematic perspective view of the components of the aerosol-generating article of FIG. 8A, with different reference signs assigned to the different dimensions of the components;

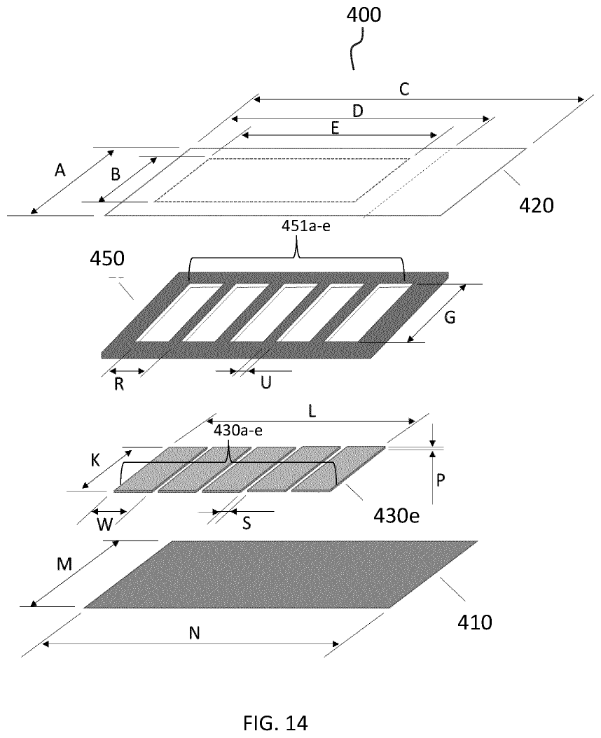

FIG. 14 is a schematic perspective view of the components of the aerosol-generating article of FIG. 10A, with different reference signs assigned to the different dimensions of the components;

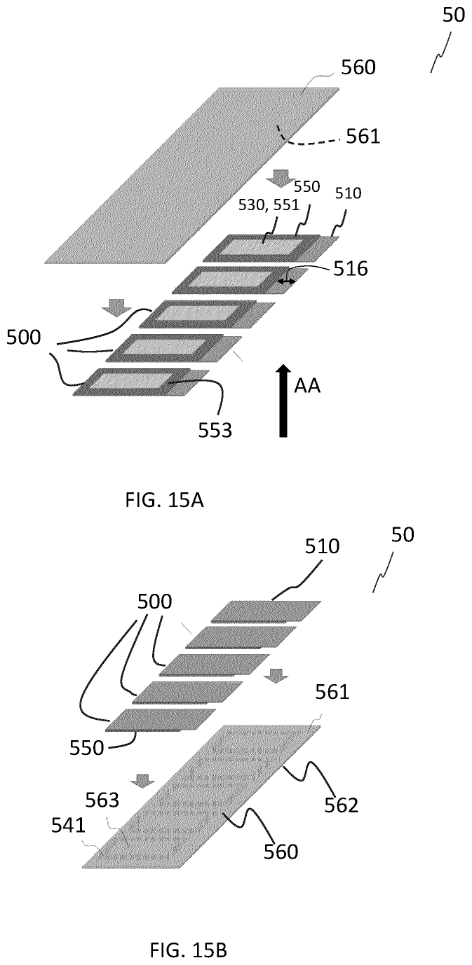

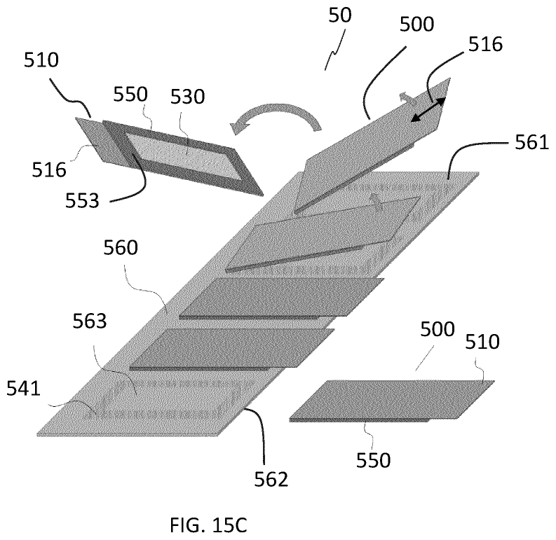

FIG. 15A is a schematic perspective view of the components of an embodiment of an assembly, the assembly including a plurality of aerosol-generating articles and a supporting sheet to which the plurality of aerosol-generating articles are intended to be peelably attached;

FIG. 15B corresponds to FIG. 15A but viewed in the direction of arrow AA of FIG. 15A;

FIG. 15C is a schematic perspective view of the assembly formed by the plurality of aerosol-generating articles when peelably attached to the supporting sheet of FIGS. 15A and 15B, also illustrating how different ones of the aerosol-generating articles may be peelably removed from the supporting sheet;

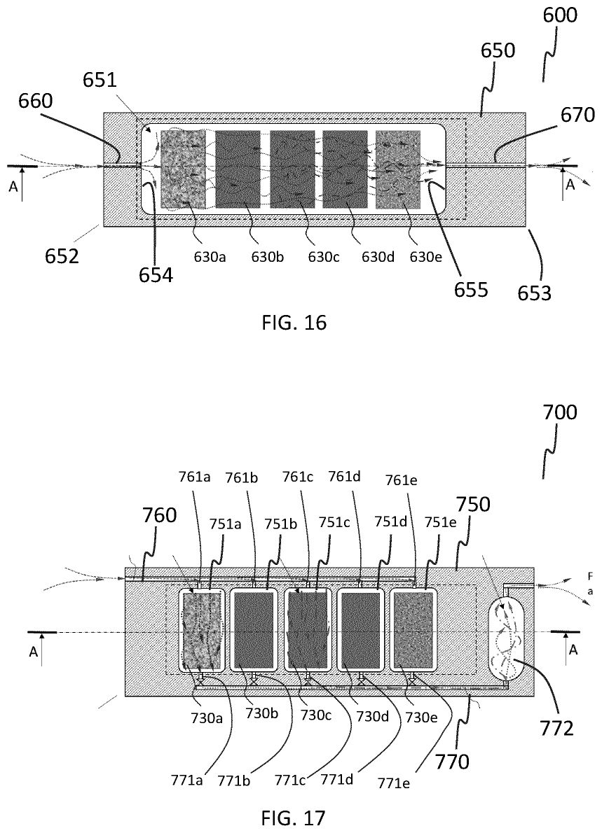

FIGS. 16 and 17 show a plan view of a section through fifth and sixth embodiments of an aerosol-generating article.

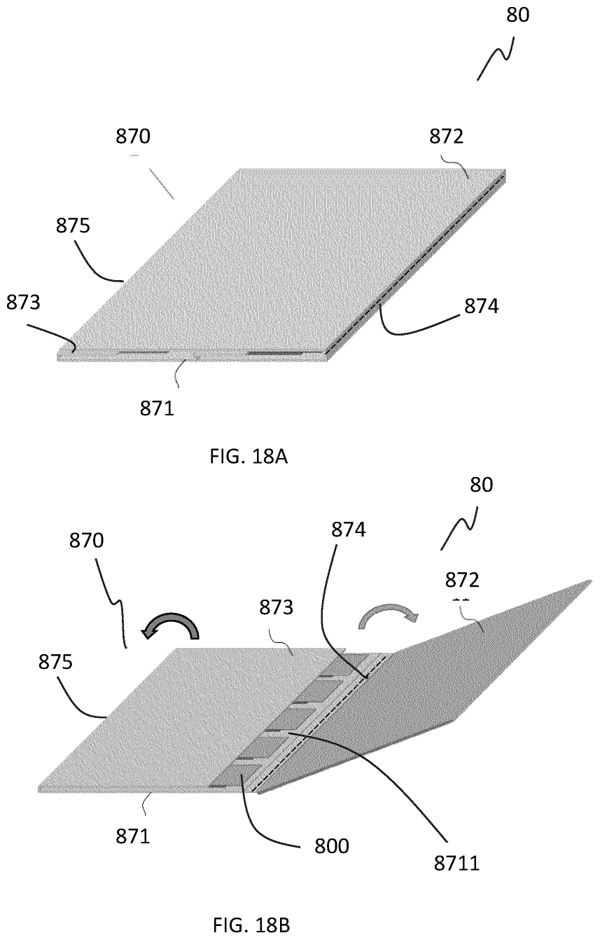

FIG. 18A is a schematic perspective view of a packaging assembly according to a first embodiment;

FIG. 18B is a schematic perspective view of the packaging assembly of FIG. 18A in a partially opened condition;

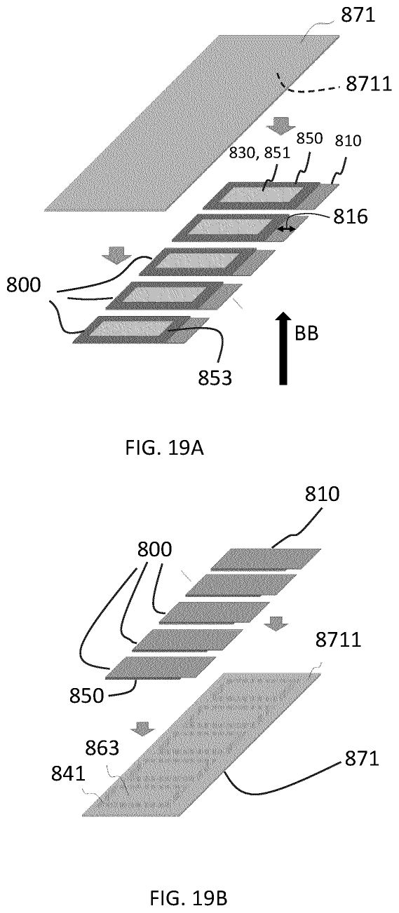

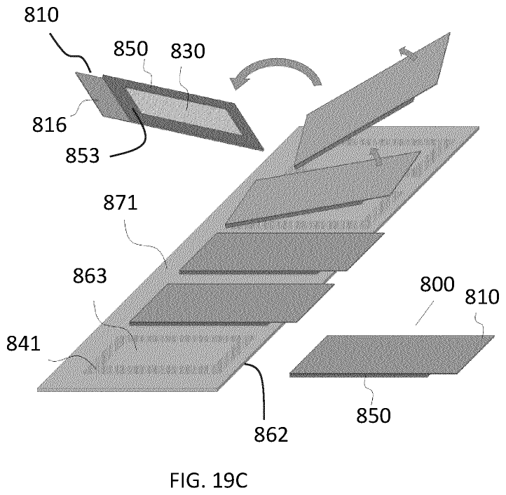

FIG. 19A is a schematic perspective view of a plurality of aerosol-generating articles before their releasable attachment to a planar wall portion of the packaging assembly of FIGS. 18A and 18B;

FIG. 19B corresponds to FIG. 19A but viewed in the direction of arrow BB of FIG. 19A;

FIG. 19C is a schematic perspective view of the plurality of aerosol-generating articles of FIGS. 19A and 19B when releasably attached to the planar wall portion;

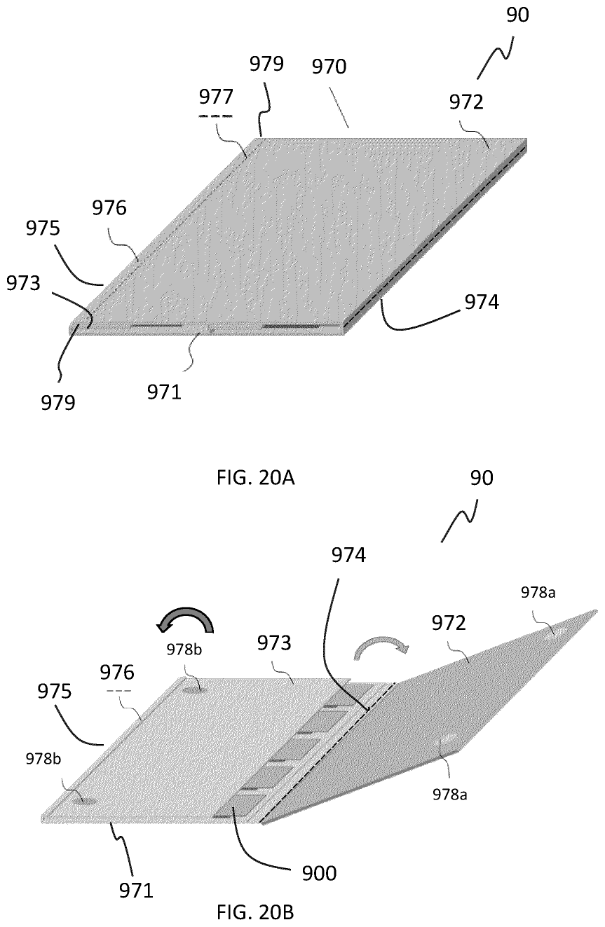

FIG. 20A is a schematic perspective view of a packaging assembly according to a second embodiment;

FIG. 20B is a schematic perspective view of the packaging assembly of FIG. 20A in a partially opened condition;

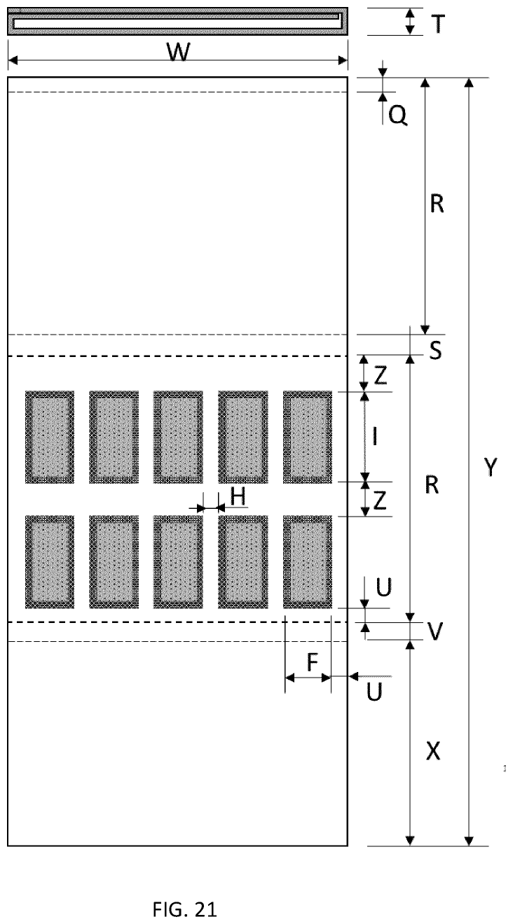

FIG. 21 is a schematic perspective view of the components of the packaging assembly of FIGS. 18A-18B or FIGS. 20A-20B, with different reference signs assigned to the different dimensions of the components.

A first embodiment of an aerosol-generating article 100 is shown in FIGS. 1A to 2B. The aerosol-generating article has a first sheet 110 and a second sheet 120. The first and second sheets 110, 120 are each generally planar and rectangular in plan. The second sheet 120 overlies the first sheet 110. As can be seen from FIG. 1A, the second sheet 120 is slightly longer in length than the first sheet 110. A portion of sensorial media 130 is disposed on a surface of the first sheet 110. The portion of sensorial media 130 is sized and positioned on an impermeable surface 111 of the first sheet 110 so as to be inwardly offset from a peripheral edge 113 of the first sheet. The offset is indicated by the double-headed arrows labelled 112 in FIG. 2B. Opposing impermeable surfaces 111, 121 of the first and second sheets 110, 120 are peelably bonded to each other around the portion of sensorial media 130 to define a seal path between the first and second sheets 110, 120. So, for the aerosol-generating article 100 of FIG. 1A, the portion of sensorial media 130 is sealed between the opposing impermeable surfaces 111, 121 of the first and second sheets 110, 120. For the illustrated embodiment, the first and second sheets 110, 120 are in intimate contact with the sensorial media 130, with there being no air gap between the sensorial media and the opposing impermeable surfaces 111, 121 of the first and second sheets. The portion of sensorial media 130 is provided as a thin layer disposed on the impermeable surface 111 of the first sheet 110. Although the portion of sensorial media 130 extends above the surface 111 of the first sheet 110 by a height dimension (designated “P” in FIG. 6), the height P is preferably sufficiently small in size that an outward-facing surface 124 of the second sheet 120 still defines a generally planar surface when sealed to the first sheet 110 over the portion of sensorial media 130. For example, the outward-facing surface 124 of the second sheet 120 may deviate from a strictly planar profile by no more than 3 millimetres over the surface area of the second sheet. In alternative embodiments, this allowable deviation from a strictly planar profile for the outward-facing surface 124 of the second sheet 120 may be more or less than 3 millimetres, such as being 5 millimetres or less, or 4 millimetres or less, or 2 millimetres or less, or 1 millimetre or less, or 0.5 millimetre or less.

FIG. 1B shows an exploded view of the components of the aerosol-generating article 100 of FIG. 1A. For the illustrated embodiment, both the first and second sheets 110, 120 have a similar laminate construction. The laminate construction (not shown) may have a paper-based layer, a metal foil layer and an impermeable coating successively laid over each other. The paper-based layer of each of the first and second sheets 110, 120 forms a respective outward-facing surface 114, 124 of the aerosol-generating article 100 of FIG. 1A. The impermeable coating of each of the first and second sheets 110, 120 defines the opposing impermeable surfaces 111, 121 of the first and second sheets. The opposing impermeable surfaces 111, 121 of the first and second sheets 110, 120 form first and second inward-facing surfaces of the aerosol-generating article 100, with the portion of sensorial media 130 sandwiched in-between. In alternative embodiments, a cellulose-based layer may be used in place of the paper-based layer. In other alternative embodiments, the paper-based layer may comprise a cellulose-based material. For the illustrated embodiment, the metal foil layer is formed from aluminium. However, in alternative embodiments other metals or materials may be used which are thermally conductive. For the illustrated embodiments, the first and second sheets 110, 120 have a uniform thickness of between 0.07 to 0.75 millimetres and a basis weight of between 45 to 140 grammes per metre. The majority of the thickness of the first and second sheets is due to the paper-based layer, with the impermeable coating having a thickness of between 0.75 and 1.5 microns. The impermeable coating is water-impermeable. The impermeable coating may include dispersions based on co-polymers consisting of acrylic ester and styrene, or based on styrene-butadiene copolymers, applied during paper processing as aqueous dispersions of co-polymers of styrene-butadiene with a solids content of approximately 50%.

In other embodiments, one or both of the first and second sheets may lack any paper-based layer and instead be formed from a metallic layer (for example, a layer of aluminium) and an impermeable coating overlaid onto the metallic layer. The thickness of the respective sheet for such an embodiment may be between 1.1 and 4.5 microns.

In still other embodiments, the second sheet may be formed from one or more polymers selected to render the second sheet partially or wholly transparent. The second sheet may be formed from polymeric compound compositions incorporating one or more of vinyl-based polymers and co-polymers, polyurethane, acrylic, cellulose and its derivatives.

As shown in FIGS. 1B and 2B, a layer of adhesive 140 is arranged on the impermeable coating which defines the impermeable surface 121 of the second sheet 120. The layer of adhesive 140 is provided as an annular portion 141 sized and located on the impermeable surface 121 of the second sheet 120 to surround the portion of sensorial media 130 when the first and second sheets 110, 120 are sealed to each other. The impermeable surface 121 of the second sheet 120 is free of adhesive in the region 125 of the second sheet 120 which overlies the portion of sensorial media 130 when the first and second sheets 110, 120 are sealed to each other. The adhesive 140 is selected such that the annular portion 141 defines a peelable and hermetic seal between the first and second sheets 110, 120 surrounding the portion of sensorial media 130. The adhesive 140 may be a polyethylene (PE) adhesive coating. The PE adhesive coating may be water-based or solvent-based. Alternatively, acrylic-based adhesives may be used as the adhesive.

As shown in FIGS. 1A and 1B, a portion of the second sheet 120 outward of the annular portion of adhesive 141 defines a tab 126. The tab 126 is not adhered to the first sheet 110. The length of the tab 126 is indicated in FIGS. 1A and 1B by the double-headed arrow associated with reference sign 126. As can be seen in FIG. 1A, a free edge 126a of the tab 126 extends slightly beyond a corresponding edge 115 of the first sheet 110.

The sensorial media 130 may be in the form of gel-based composition. By way of example, the sensorial media 130 may be a gel-based composition comprising nicotine. The gel-based composition may include a gelling agent, with glycerol dispersed in the gelling agent and nicotine dispersed in the glycerol. The gelling agent may be xanthan gum, low acyl gellan, or a mixture thereof in approximately equal amounts. The nicotine may be present in a concentration of between 1 and 3% wt of the sensorial media 130. On the application of heat to the sensorial media 130, vapours containing nicotine are evolved from the sensorial media. In an alternative embodiment, the sensorial media 130 may be a gel-based composition containing flavouring agents. A single type of flavouring agent or a blend of different types of flavouring agent may be used. The flavouring agent(s) may be present in a concentration of between 1 and 4% wt of the sensorial media, preferably between 1 and 2% wt of the sensorial media 130. The flavouring agents may include any one or more of complex volatile oil, anise oil, aldehyde/vanillin, ginger oil, peppermint oil, lemongrass oil, tobacco extract oil, and menthol oil. It is desirable that the gel-based composition be physically stable over a broad range of environmental conditions, thereby allowing for long-term storage of the aerosol-generating article with little to no degradation of the sensorial media 130. In other embodiments, the sensorial media 130 may be a solid substrate, or a substrate containing both liquid and solid phases. The sensorial media 130 may contain tobacco.

The aerosol-generating article 100 of FIG. 1A is in a state suitable for long-term storage without degradation of the sensorial media 130. The adhesive annular portion 141 defining the seal path between the first and second sheets 110, 120 helps to reduce or eliminate loss of moisture from the sensorial media 130.

Prior to use of the aerosol-generating article 100, the sensorial media 130 is first exposed. Exposure of the sensorial media 130 allows vapours evolved from the sensorial media on heating of the aerosol-generating article 100 to escape from the confines of the article. The aerosol-generating article 100 of FIG. 1A is preferably intended for coupling to an aerosol-generating device (not shown) having a heating arrangement. However, the sensorial media 130 is first exposed prior to coupling of the aerosol-generating article 100 with the aerosol-generating device. To achieve this exposure, a user would engage their fingers and thumb with the tab 126 of the second sheet 120 and pull the tab in the direction shown by the arrow in FIG. 2A. The extension of the tab 126 beyond the edge 115 of the first sheet 110 allows a user to easily engage their fingers with the underside of the tab. The user would apply sufficient force when pulling on the tab 126 to cause the adhesive bond between the first and second sheets 110, 120 to progressively fracture, thereby resulting in the second sheet progressively peeling away from the first sheet until the second sheet is fully detached from the first sheet, as shown in FIG. 2B. Detachment of the second sheet 120 from the first sheet 110 leaves the sensorial media 130 exposed to the ambient environment, as shown in FIG. 2B. The aerosol-generating article 100 may then be coupled to the aerosol-generating device (not shown) such that the sensorial media 130 is positioned in thermal communication with a heating arrangement of the aerosol-generating device. The heating arrangement may an electrically powered heating arrangement. By way of example, the aerosol-generating device may include a battery for powering the heating arrangement. The heating arrangement may have a resistive heating element, with heat from the resistive heating element radiating onto the exposed sensorial media 130 to cause heating of the sensorial media. Where the first sheet 110 includes a metallic layer, such as the metal foil layer described above, heat radiated onto the first sheet spreads across the metal foil layer and assists in heating of the sensorial media 130 disposed on the first sheet. In an alternative embodiment, the heating arrangement may include an inductor and a susceptor positioned relative to each other such that a flow of alternating current through the inductor induces heating of the susceptor through one or more of eddy current heating or magnetic hysteresis heating. Heat from the susceptor would radiate onto the exposed sensorial media 130 to cause heating of the sensorial media and of the first sheet 110 in a similar manner to where the heating arrangement is a resistive heating arrangement.

FIGS. 3A to 4B show a second embodiment of an aerosol-generating article 200. Features of aerosol-generating article 200 in common with aerosol-generating article 100 are referred to with like reference signs but preceded with numeral “2” instead of numeral “1”. The aerosol-generating article 200 differs from aerosol-generating article 100 in terms of the sensorial media disposed on the impermeable surface 211 of the first sheet 210. Instead of a single portion of sensorial media being disposed on the surface 211 of the first sheet 210, the aerosol-generating article 200 has a plurality of portions of sensorial media 230a-e disposed on the surface of the first sheet. For the illustrated embodiment of FIGS. 3A to 4B, the plurality of portions of sensorial media 230a-e are five in number. However, it will be appreciated that in other embodiments, the plurality of portions of sensorial media 230a-e may be greater or fewer in number than five. The plurality of portions of sensorial media 230a-e are successively aligned along a length direction of the first sheet 210. Each portion of sensorial media is spaced apart from an adjacent portion of sensorial media. Each portion of sensorial media is provided as a thin layer disposed on the impermeable surface 211 of the first sheet 210. Although each of the portions of sensorial media 230a-e extends above the impermeable surface 211 of the first sheet 210 by a height dimension (designated “P” in FIG. 7), the height P is preferably sufficiently small in size that the outward-facing surface 224 of the second sheet 220 still defines a generally planar surface when sealed to the first sheet 210 by the adhesive annular portion 241 defining the seal path between the first and second sheets 210, 220. For example, the outward-facing surface 224 of the second sheet 220 may deviate from a strictly planar profile by no more than 3 millimetres over the surface area of the second sheet. In alternative embodiments, this allowable deviation from a strictly planar profile may be more or less than 3 millimetres, such as being 5 millimetres or less, or 4 millimetres or less, or 2 millimetres or less, or 1 millimetres or less, or 0.5 millimetres or less.

Each of the portions of sensorial media 230a-e may be identical in composition to each other. However, as illustrated in the embodiment of FIG. 5A, a first portion 230a of the plurality of portions of sensorial media may be different in composition to the other portions 230b-e. For example, the first portion 230a may comprise one or more flavouring agents, such as any one or more of complex volatile oil, anise oil, aldehyde/vanillin, ginger oil, peppermint oil, lemongrass oil, tobacco extract oil, and menthol oil, whereas the other portions 230b-e may comprise an aerosol-forming substrate comprising nicotine and an aerosol former, such as glycerin. Alternatively, as illustrated in the embodiment of FIG. 5B, the plurality of portions of sensorial media 230a-e may include three different compositions. More specifically, the first portion of sensorial media 230a may have a first composition, with the second, third and fourth portions 230b-d of sensorial media having a second composition, and the fifth portion 230e of sensorial media having a third composition. The first, second and third compositions may be different to each other. By way of example, the first and third compositions may comprise different flavouring agents, where the flavouring agents comprise any one or more of complex volatile oil, anise oil, aldehyde/vanillin, ginger oil, peppermint oil, lemongrass oil, tobacco extract oil, and menthol oil, whereas the second composition may be an aerosol-forming substrate comprising nicotine and an aerosol former, such as glycerin.

The second sheet 220 is removed from the first sheet 210 to expose the portions of sensorial media 230a-e by a user pulling on the tab 226 in the same manner as described above for the aerosol-generating article 100 of FIGS. 1A to 2B.

FIGS. 6 and 7 are schematic perspective views of the components of the aerosol-generating articles 100, 200 of FIGS. 1A to 2B and 3A to 4B respectively. Different reference signs have been assigned to the different dimensions of the components of the aerosol-generating articles 100, 200. Table 1 below shows some exemplary ranges for the various dimensions of the aerosol-generating articles 100, 200:

TABLE 1

| | Preferable Range | More Preferable Range |
|---|---|---|
| Dimension | (millimetres) | (millimetres) |
| A | 8 to 31 | 11 to 25 |
| B | 6 to 25 | 8 to 20 |
| C | 28 to 62 | 35 to 48 |
| D | 18 to 54 | 24 to 39 |
| E | 12 to 47 | 18 to 32 |
| K | 4 to 22 | 6 to 17 |
| L | 10 to 45 | 16 to 30 |
| M | 9 to 30 | 12 to 23 |
| N | 21 to 52 | 28 to 40 |
| P | 0.15 to 4.5 | 0.5 to 2.5 |
| S | 0.5 to 2.5 | 0.75 to 1.5 |
| W | 1.5 to 7 | 2.5 to 5.5 |

FIGS. 8A to 9B show a third embodiment of an aerosol-generating article 300. Features of the aerosol-generating article 300 in common with aerosol-generating article 100 are referred to with like reference signs but preceded with numeral “3” instead of numeral “1”. The aerosol-generating article 300 differs from aerosol-generating article 100 in that a frame 350 separates the first sheet 310 from the second sheet 320. The frame 350 is rectangular in plan and of uniform thickness. The frame 350 encloses a single cavity 351, the cavity extending through the thickness of the frame between opposed first and second surfaces 352, 353 of the frame. The first and second surfaces 352, 353 define lower and upper surfaces respectively of the frame 350 and are each generally planar. It will be understood that the terms “lower” and “upper” are used here merely to differentiate between the two surfaces 352, 353 and are descriptive of the point from which the aerosol-generating article 300 is viewed in FIGS. 8A to 9B.

The first sheet 310 is fixed to the first surface 352 of the frame 350 to cover the bottom of the cavity 351. An adhesive (not shown) may be used to secure the first sheet 310 to the first surface 352 of the frame 350. The adhesive may in the form of a layer of adhesive provided on the first surface 352 of the frame 350 or on a corresponding portion of the impermeable surface 311 of the first sheet 310. However, the impermeable surface 311 of the first sheet 310 is free of adhesive in the region of the first sheet covering the bottom of the cavity 351. The first sheet 310 may have the same construction as the first sheet 110, 210 of the aerosol-generating articles 100, 200 described above.

A single portion of sensorial media 330 is disposed directly on the impermeable surface 311 of the first sheet 310 within the cavity 351 of the frame 350. The sensorial media 330 may be as described above for aerosol-generating article 100. The sensorial media 330 fills the cavity 351 without extending above the second surface 353 of the frame 350. Preferably, the sensorial media 330 extends from the impermeable surface 311 of the first sheet 310 by a height dimension (designated “P” in FIG. 13), which is less than the height of the frame 350 (designed “O” in FIG. 13). In this manner, the second sheet 320 is able to retain a generally planar profile when attached to the second surface 353 of the frame 350 to overlie the sensorial media 330 within the cavity 351.

For the aerosol-generating article 300 of FIGS. 8A to 9B, the second sheet 320 is peelably attached to the second surface 353 of the frame 350, rather than directly to the first sheet 310. The second sheet 320 may have the same construction as the second sheet 120, 220 of aerosol-generating articles 100, 200 described above. As shown in FIG. 8B, a layer of adhesive 340 is arranged on the impermeable surface 321 of the second sheet 320 to enable the peelable attachment of the second sheet to the frame 350. The layer of adhesive 340 is provided as an annular adhesive portion 341 corresponding in size and shape to the second surface 353 of the frame 350. The impermeable surface 321 of the second sheet 320 is free of adhesive in the region 325 of the second sheet which overlies the cavity 351 when the second sheet is attached to the second surface 353 of the frame 350. The adhesive is selected to define a peelable and hermetic seal between the second sheet 320 and the second surface 353 of the frame 350. The adhesive may be a polyethylene (PE) adhesive coating. The PE adhesive coating may be water-based or solvent-based. Alternatively, acrylic-based adhesives may be used as the adhesive. As for aerosol-generating articles 100, 200, the tab 326 of the second sheet 320 is located outward of the annular adhesive portion 341. As can be seen in FIG. 8A, a free edge 326a of the tab 326 extends slightly beyond a corresponding edge 315 of the first sheet 310. The second sheet 320 forms a peelable lid of the aerosol-generating article 300.

Prior to use of the aerosol-generating article 300, the user would peel the peelable lid (i.e., the second sheet 320) away from the second surface 353 of the frame 350 to expose the sensorial media 330. More specifically, the user would engage their fingers and thumb with the tab 326 of the peelable lid 320 and pull the tab in the direction shown by the arrow in FIG. 9A to detach the peelable lid from the frame 350. The user would apply sufficient force when pulling on the tab 326 to cause the adhesive bond between the peelable lid 320 and second surface 353 of the frame 350 to progressively fracture, thereby resulting in the peelable lid progressively peeling away from the frame until the peelable lid is fully detached from the frame, as shown in FIG. 9B.

The adhesive of the annular adhesive portion 341 used to adhere the second sheet 320 to the second surface 353 of the frame 350 is different to the adhesive used to adhere the first sheet 310 to the first surface 352 of the frame. More specifically, adhesive formulations are chosen which result in the bond between the first sheet 310 and the frame 350 being stronger than the bond between the second sheet 320 and the frame 350. This helps to ensure that the frame 350 and the first sheet 310 remain adhered to each other whilst the user peels the second sheet 320 away from the frame 350.

The frame 350 is formed from a paper-based material having a basis weight of between 200 and 500 grammes per metre. The frame 350 is adapted to be water impermeable. By way of example, the surface of the frame 350 may be coated with a layer of an impermeable material. The layer of impermeable material may include dispersions based on co-polymers consisting of acrylic ester and styrene, or based on styrene-butadiene co polymers. The frame 350 has a height of between 1 and 5.5 millimetres, or more preferably between 1.25 and 3.5 millimetres.

FIGS. 10A to 11B show a fourth embodiment of an aerosol-generating article 400. Features of aerosol-generating article 400 in common with aerosol-generating article 300 are referred to with like reference signs but preceded with numeral “4” instead of numeral “3”. The aerosol-generating article 400 differs from aerosol-generating article 300 in terms of the frame 450 enclosing a plurality of cavities 451a-e rather than only single cavity 451. More specifically, the frame 450 has an annular perimeter wall 454, with lateral wall portions 455 extending between opposing sides of the perimeter wall to define the cavities 451a-e. The plurality of cavities 451a-e are successively arranged along a length direction of the frame 450. A layer of adhesive 440 is arranged on the impermeable surface 421 of the second sheet 420 to enable the peelable attachment of the second sheet to the frame 450. The layer of adhesive 440 is provided as an adhesive portion 441 corresponding in size and shape to the second surface of 453 of the frame 450 as defined by perimeter wall 454 and lateral wall portions 455. The impermeable surface 421 of the second sheet 420 is free of adhesive in regions 425a-e overlying respective ones of the cavities 451a-e. A plurality of portions 430a-e of sensorial media are provided, with each one of the cavities 451a-e containing a respective one of the portions of sensorial media. For the illustrated embodiment of FIGS. 10A to 11B, the plurality of portions of sensorial media 430a-e are five in number. However, it will be appreciated that in other embodiments, the plurality of portions may be greater or fewer in number than five.

Prior to use of the aerosol-generating article 400, the user would peel the peelable lid (i.e., the second sheet 420) away from the second surface 453 of the frame 450 to expose the portions of sensorial media 430a-e. More specifically, in a similar manner to aerosol-generating article 300, the user would engage their fingers and thumb with the tab 426 of the peelable lid 420 and pull the tab in the direction shown by the arrow in FIG. 11A to detach the peelable lid from the frame 450. The user would apply sufficient force when pulling on the tab 426 to cause the adhesive bond between the peelable lid 420 and second surface 453 of the frame 450 to progressively fracture, thereby resulting in the peelable lid progressively peeling away from the frame until the peelable lid is fully detached from the frame, as shown in FIG. 11B.

Each of the portions of sensorial media 430a-e may be identical in composition to each other. However, as illustrated in the embodiment of FIG. 12A, a first portion 430a of the plurality of portions of sensorial media may be different in composition to the other portions 430b-e of the plurality of portions. For example, the first portion 430a may comprise one or more flavouring agents, such as any one or more of complex volatile oil, anise oil, aldehyde/vanillin, ginger oil, peppermint oil, lemongrass oil, tobacco extract oil, and menthol oil, whereas the other portions of sensorial media 430b-e may be an aerosol-forming substrate comprising nicotine and an aerosol former, such as glycerin. Alternatively, as illustrated in the embodiment of FIG. 12B, the plurality of portions 430a-e of sensorial media may include three different compositions. More specifically, the first portion 430a of sensorial media has a first composition, with the second, third and fourth portions 430b-d of sensorial media having a second composition, and the fifth portion 430e of sensorial media having a third composition.

The first, second and third compositions are different to each other. By way of example, the first and third compositions may comprise different flavouring agents, where the flavouring agents comprise any one or more of complex volatile oil, anise oil, aldehyde/vanillin, ginger oil, peppermint oil, lemongrass oil, tobacco extract oil, and menthol oil, whereas the second composition may be an aerosol-forming substrate comprising nicotine and an aerosol former, such as glycerin.

FIGS. 13 and 14 are schematic perspective views of the components of the aerosol-generating articles 300, 400 of FIGS. 8A to 9B and 10A to 11B respectively. Different reference signs have been assigned to the different dimensions of the components of the aerosol-generating articles 300, 400. Table 2 below shows some exemplary ranges for the various dimensions of the aerosol-generating articles 200, 400:

TABLE 2

| | Preferable Range | More Preferable Range |
|---|---|---|
| Dimension | (millimetres) | (millimetres) |
| A | 8 to 31 | 11 to 25 |
| B | 7 to 29 | 11 to 26 |
| C | 33 to 77 | 38 to 62 |
| D | 26 to 65 | 31 to 55 |
| E | 12 to 47 | 18 to 36 |
| F | 9 to 30 | 13 to 27 |
| G | 6 to 27 | 10 to 24 |
| I | 19 to 54 | 24 to 45 |
| J | 12 to 47 | 17 to 38 |
| K | 4 to 22 | 6 to 17 |
| L | 10 to 45 | 16 to 30 |
| M | 9 to 30 | 12 to 23 |
| N | 26 to 63 | 31 to 52 |
| O | 1 to 5.5 | 1.25 to 3.5 |
| P | 0.15 to 4.5 | 0.5 to 2.5 |
| R | 2 to 9 | 3 to 7 |
| S | 1 to 6 | 1.75 to 5 |
| U | 0.25 to 4 | 0.5 to 3 |
| W | 1.5 to 7 | 2.5 to 5.5 |

FIGS. 15A to 15C show an embodiment of the components of an assembly 50. The assembly has a supporting sheet 560 and a plurality of aerosol-generating articles 500. Each of the aerosol-generating articles 500 illustrated in FIGS. 15A to 15C has a first sheet 510 and a frame 550. The frame 550 is rectangular in plan and of uniform thickness. The frame 550 encloses a single cavity 551, the cavity extending through the thickness of the frame between opposed first and second surfaces of the frame. The first sheet 510 is fixed to a first surface of the frame 550 to cover one side of the cavity. An adhesive (not shown) may be used to secure the first sheet 510 to the first surface of the frame 550. The adhesive may in the form of a layer of adhesive provided on the first surface of the frame 550 or a corresponding part of the first sheet 510. However, the surface of the first sheet 510 is free of adhesive in the region of the first sheet overlying the cavity 551. The first sheet 510 may be formed of the same materials as the first sheet of the aerosol-generating articles 100, 200, 300, 400 described above. A portion of the first sheet 510 outward of the frame 550 defines a tab 516. A portion of sensorial media 530 is disposed on the surface of the first sheet 510 within the cavity 551 of the frame 550. The frame 550 may be formed of the same materials as the frame of the aerosol-generating articles 300, 400 of FIGS. 8A to 9B and FIGS. 10A to 11B.

The supporting sheet 560 is sufficiently large in size to allow up to five of the aerosol-generating articles 500 to be attached to a surface 561 of the supporting sheet. However, it will be appreciated that the supporting sheet 560 may be larger or smaller in size depending on how many aerosol-generating articles 500 are desired to be attached to the supporting sheet. The supporting sheet 560 may have a laminated construction formed of a paper-based substrate overlaid with an impermeable coating. The paper-based substrate may be paperboard. The impermeable coating may be formed from dispersions based on co-polymers consisting of acrylic ester and styrene, or based on styrene-butadiene co polymers, applied during paper processing as aqueous dispersions of co-polymers of styrene-butadiene with a solids content of approximately 50%. The impermeable coating may form the surface 561 of the supporting sheet 560 to which the plurality of aerosol-generating articles 500 are attached. In alternative embodiments, a cellulose-based layer may be used in place of the paper-based layer.

Each of the aerosol-generating articles 500 are spaced apart from each other along the surface 561 of the supporting sheet 560. Each of the aerosol-generating articles 500 are positioned on the supporting sheet 560 such that the tab 516 of the first sheet 510 of each aerosol-generating article 500 overhangs a free edge 562 of the supporting sheet 560. As shown in FIGS. 15B and 15C, separate annular portions of adhesive 541 are arranged on the surface 561 of the supporting sheet 560. A separate portion of adhesive 541 is provided for each one of the aerosol-generating articles 500 and corresponds in size and shape to the second surface 553 (see FIG. 15A) of the frame 550 of the respective aerosol-generating article. The frame 550 of each aerosol-generating article 500 is attached to the surface 561 of the supporting sheet 560 by an adhesive bond established by the corresponding portion of adhesive 541. The sealing of the aerosol-generating articles 500 to the supporting sheet 560 results in the sensorial media 530 of each article being hermetically sealed within the cavity 551 of the frame 550 of the article. The impermeable coating defining the surface 561 of the supporting sheet 560 is free of adhesive in the region 563 of the supporting sheet which overlies the cavity (see FIG. 15B). The adhesive used for the portions of adhesive 541 is selected so as to define a peelable and hermetic seal between the frame 550 and the supporting sheet 560. The adhesive may be a polyethylene (PE) adhesive coating. The PE adhesive coating may be water-based or solvent-based. Alternatively, acrylic-based adhesives may be used as the adhesive.

When a user wishes to expose the sensorial media 530 ready for use of the aerosol-generating articles 500, they would engage their fingers and thumb with the tab 516 and pull the tab in the direction shown by the arrow in FIG. 15C to progressively peel the aerosol-generating article away from the surface 561 of the supporting sheet 560. The generally flat planar construction of each of the aerosol-generating articles 500 and the supporting sheet 560 provides a space efficient way of storing multiple ones of the aerosol-generating articles.

The adhesive of the adhesive portion 541 used to adhere the second surface 553 of the frame 550 to the supporting sheet 560 is different to the adhesive used to adhere the first surface of the frame 550 to the first sheet 510. More specifically, adhesive formulations are chosen which result in the bond between the first sheet 510 and the frame 550 being stronger than the bond between the supporting sheet 560 and the frame 550. This helps to ensure that the frame 550 and the first sheet 510 remain adhered to each other whilst the user pulls on the tab 516 to peel the aerosol-generating article 500 away from the supporting sheet 560.

The assembly 50 formed by the supporting sheet 560 and the plurality of aerosol-generating articles 500 may itself be stored inside a packaging container (not shown). The packaging container may contain a plurality of the assemblies 50. The generally flat planar construction of each of the aerosol-generating articles 500 and the supporting sheet 560—and the resulting assembly 50—provides a space-efficient way of storing a large number of aerosol-generating articles within a packaging container.

FIGS. 16 and 17 show embodiments of aerosol-generating articles 600, 700 based on the aerosol-generating article 300 of FIGS. 8A to 9B and the aerosol-generating article 400 of FIGS. 10A to 11B respectively. Each of the aerosol-generating articles 600, 700 have a frame 650, 750 (in a similar manner to the frame 350 of aerosol-generating article 300 and the frame 450 of aerosol-generating article 400). FIGS. 16 and 17 are a plan view on a section through the respective frames 650, 750.

For the aerosol-generating article 600 of FIG. 16, the frame 650 encloses a single cavity 651. Five portions 630a-e of sensorial media are disposed within the cavity 651. The frame 650 has an airflow inlet channel 660 and an airflow outlet channel 670 defined within the structure of the frame. The airflow inlet channel 660 and airflow outlet channel 670 are located at opposite first and second longitudinal ends 652, 653 of the frame 650. More specifically, the airflow inlet channel 660 extends between first longitudinal end 652 of the frame 650 and a first end 654 of the cavity 651. The airflow outlet channel 670 extends between a second end 655 of the cavity 651 and second longitudinal end 653 of the frame. In response to a suction force acting on the outlet of the airflow outlet channel 670, airflow may be drawn into the cavity 651 through the airflow inlet channel 660 from outside of the aerosol-generating article 600. The suction force would cause the airflow drawn into the cavity 651 to flow over and/or through the portions of sensorial media 630a-e disposed within the cavity 651 of the frame 650. Where sufficient heat is applied to the portions of sensorial media 630a-e (for example, where the aerosol-generating article 600 is coupled to an aerosol-generating device having a heating arrangement as previously described), vapours are evolved from the sensorial media, with these vapours becoming entrained with the airflow drawn into the cavity 651. The entrained airflow would then be drawn into and through the airflow outlet channel 670 under the action of the applied suction force, to thereby exit the aerosol-generating article 600 for subsequent inhalation by a user. The frame 650 may be employed as the frame 350 of the aerosol-generating article 300 previously described for FIGS. 8A to 9B. The suction force may be applied by a user inhaling on an end of the aerosol-generating article 600, or inhaling on a mouthpiece of an aerosol-generating device coupled to the aerosol-generating article.

For the aerosol-generating article 700 of FIG. 17, the frame 750 encloses five distinct cavities 751a-e. The frame contains five portions 730a-e of sensorial media, with each of the cavities 751a-e containing one of the portions of sensorial media. The frame 750 has an airflow inlet channel 760 and an airflow outlet channel 770 defined within the structure of the frame. The airflow inlet channel 760 and airflow outlet channel 770 are defined within laterally opposed end walls of the frame 750. Distinct airflow sub-channels 761a-e extend from the airflow inlet channel 760 to each of the cavities 751a-e. In a similar manner, distinct airflow sub-channels 771a-e extend from each of the cavities 751a-e to the airflow outlet channel 770. So, the airflow inlet channel 760 serves as an inlet manifold for supplying an airflow to the plurality of cavities 751a-e via respective airflow sub-channels 761a-e. Similarly, the airflow outlet channel 770 serves as an outlet manifold for allowing the exit of airflow from the plurality of cavities 751a-e via respective airflow sub-channels 771a-e to outside of the aerosol-generating article 700. In response to a suction force acting on the outlet of the airflow outlet channel 770, airflow may be drawn in to each of the cavities 751a-e through the airflow inlet channel 760 and airflow sub-channels 761a-e from outside of the aerosol-generating article 700. The suction force would cause the airflow drawn into the cavities 751a-e to flow over and/or through the portions of sensorial media 730a-e disposed within the distinct cavities 751a-e. Where sufficient heat is applied to the portions of sensorial media 730a-e (for example, where the aerosol-generating article 700 is coupled to an aerosol-generating device having a heating arrangement as previously described), vapours are evolved from each portion of sensorial media, with these vapours becoming entrained with the airflow drawn into the respective cavity 751a-e. The entrained airflow would then be drawn into and through the airflow outlet channel 770 via the respective airflow sub-channels 771a-e under the action of the applied suction force, to thereby exit the aerosol-generating article 700 for subsequent inhalation by a user. The airflow outlet channel 770 includes a mixing chamber 772. The mixing chamber 772 is provided to promote homogenous mixing of the entrained airflows received from each of the cavities 751a-e. The frame 750 may be employed as the frame 450 of the aerosol-generating article 400 previously described for FIGS. 10A to 11B. The suction force may be applied by a user inhaling on an end of the aerosol-generating article 700, or inhaling on a mouthpiece of an aerosol-generating device coupled to the aerosol-generating article.

FIGS. 18A and 18B show perspective schematic views of a packaging assembly 80 in closed and partially open conditions respectively. The packaging assembly 80 has a plurality of aerosol-generating articles 800 and a container 870. The container 870 has first, second and third planar wall portions 871, 872, 873 foldable with respect to each other. The first, second and third planar wall portions 871, 872, 873 are formed from a common sheet of material. So, the first, second and third planar wall portions 871, 872, 873 are integrally formed as a single piece. As shown in FIG. 18B and discussed in more detail with respect to FIGS. 20A to 20C, each of the plurality of aerosol-generating articles 800 are attached to a surface 8711 of the first planar wall portion 871. The first and second planar wall portions 871, 872 are separated from each other by a first fold line 874. The first and third planar wall portions 871, 873 are separated from each other by a second fold line 875. For the embodiment illustrated in FIGS. 18A and 18B, the first, second and third planar wall portions 871, 872, 873 are rectangular in plan, with the first and second planar wall portions having the same surface area. FIG. 18A shows the packaging assembly 80 in an as-new condition, corresponding to the condition in which the packaging assembly might be purchased by a consumer. The third planar wall portion 873 is folded about the second fold line 875 to partially overlie the aerosol-generating articles 800 attached to the surface 8711 of the first planar wall portion 871. The second planar wall portion 872 is folded about the first fold line 874 to overlie the third planar wall portion 873. For the as-new condition of the packaging assembly 80 shown in FIG. 18A, the first, third and second planar wall portions 871, 872, 873 are successively stacked one above the other, being aligned so as to be generally parallel to each other. The combination of the second and third planar wall portions 872, 873 cover the aerosol-generating articles 800 attached to the underlying first planar wall portion 871. The resulting packaging assembly 80 is thereby generally planar and thin in thickness (the thickness of the packaging assembly 80 being designated by reference sign “T” in FIG. 21).

A consumer would gain access to the aerosol-generating articles 800 by first unfolding the second planar wall portion 872 about the first fold line 874 in the direction shown by the arrow in FIG. 18B. This would result in the aerosol-generating articles 800 attached to the underlying first planar wall portion 871 being partially exposed. The user would then unfold the third planar wall portion 873 about the second fold line 875 in the direction shown by the arrow in FIG. 18B to fully expose the aerosol-generating articles 800. A user would then detach one or more of the aerosol-generating articles 800 from the surface 8711 of the first planar wall portion 871 for subsequent use. Such use may include coupling of the aerosol-generating article 800 to an aerosol-generating device having a heating arrangement, as described in previous paragraphs. It will be appreciated that the third and second planar wall portions 873, 872 may be folded back into their closed positions to cover and protect the remaining aerosol-generating articles 800 still attached to the surface 8711 of the first planar wall portion 871.

The aerosol-generating articles 800 may be as described above in earlier paragraphs. For example, the aerosol-generating articles 800 may correspond to the aerosol-generating article 100 of FIGS. 1A to 2B, but without the presence of second sheet 120. Alternatively, the aerosol-generating articles 800 may correspond to the aerosol-generating article 200 of FIGS. 3A to 4B, but without the presence of second sheet 220. Alternatively, the aerosol-generating articles 800 may correspond to the aerosol-generating article 300 of FIGS. 8A to 9B, but without the presence of second sheet 320. Alternatively, the aerosol-generating articles 800 may correspond to the aerosol-generating article 400 of FIGS. 10A to 11B, but without the presence of second sheet 420. Preferably however, the aerosol-generating articles 800 may correspond to the aerosol-generating article 500 of FIGS. 15A to 15C.

FIGS. 19A to 19C illustrate how the aerosol-generating articles 800 may be peelably attached to the surface 8711 of the first planar wall portion 871 of the container 870. Only a portion of the first planar wall portion 871 is shown in FIGS. 19A to 19C, with the adjoining second and third planar wall portions 872, 873 excluded from these figures for ease of viewing. Each of the aerosol-generating articles 800 illustrated in FIGS. 19A to 19C has a first sheet 810 and a frame 850. The frame 850 is rectangular in plan and of uniform thickness. The frame 850 encloses a single cavity 851, the cavity extending through the thickness of the frame between opposed first and second surfaces of the frame. The first sheet 810 is fixed to a first surface of the frame 850 to cover one side of the cavity. An adhesive (not shown) may be used to secure the first sheet 810 to the first surface of the frame 850. The adhesive may in the form of a layer of adhesive provided on the first surface of the frame 850 or a corresponding part of the first sheet 810. However, the surface of the first sheet 810 is free of adhesive in the region of the first sheet which overlies the cavity 851. The first sheet 810 may be formed of the same materials as the first sheet of the aerosol-generating articles 100, 200, 300, 400 described above. A portion of the first sheet 810 outward of the frame 850 defines a tab 816. A portion of sensorial media 830 is disposed on the surface of the first sheet 810 within the cavity 851 of the frame 850. The frame 850 may be formed of the same materials as the frame of the aerosol-generating articles 300, 400 of FIGS. 8A to 9B and FIGS. 10A to 11B.

The first planar wall portion 871 is sufficiently large in size to allow up to five of the aerosol-generating articles 800 to be attached to the surface 8711. However, it will be appreciated that the first planar wall portion 871 may be larger or smaller in size depending on how many aerosol-generating articles 800 are desired to be attached to the supporting sheet. The first planar wall portion 871 may have a laminated construction formed of a paper-based substrate overlaid with an impermeable coating. The paper-based layer may be paperboard. The impermeable coating may form the surface 8711 of the first planar wall portion 871 to which the plurality of aerosol-generating articles 800 are attached. The impermeable coating may include dispersions based on co-polymers consisting of acrylic ester and styrene, or based on styrene-butadiene co polymers, applied during paper processing as aqueous dispersions of co-polymers of styrene-butadiene with a solids content of approximately 50%. In alternative embodiments, a cellulose-based layer may be used in place of the paper-based substrate.

Each of the aerosol-generating articles 800 are spaced apart from each other in a row along the surface 8711 of the first planar wall portion 871. Each of the aerosol-generating articles 800 are positioned on the first planar wall portion 871 such that the tab 816 of the first sheet 810 of each aerosol-generating article 800 overhangs a free edge 862 of the first planar wall portion 871 (see FIG. 19C). As shown in FIGS. 19B and 19C, separate annular portions of adhesive 841 are arranged on the surface 8711 of the first planar wall portion 871. A separate portion of adhesive 841 is provided for each one of the aerosol-generating articles 800 and corresponds in size and shape to the second surface 853 of the frame 850 of the respective aerosol-generating article. The frame 850 of each aerosol-generating article 800 is attached to the surface 8711 of the first planar wall portion 871 by an adhesive bond established by the corresponding portion of adhesive 841. The sealing of the aerosol-generating articles 800 to the first planar wall portion 871 results in the sensorial media 830 of each article being hermetically sealed within the cavity 851 of the frame 850 of the article. The impermeable coating defining the surface 8711 of the first planar wall portion 871 is free of adhesive in the region 863 of the first planar wall portion which overlies the cavity (see FIGS. 19B and 19C). The adhesive used for the portions of adhesive 841 is selected so as to define a peelable and hermetic seal between the frame 850 and the first planar wall portion 871. The adhesive may be a polyethylene (PE) adhesive coating. The PE adhesive coating may be water-based or solvent-based. Alternatively, acrylic-based adhesives may be used as the adhesive.

When a user wishes to detach one of the aerosol-generating articles 800 from the first planar wall portion 871 of the container 80, they would engage their fingers and thumb with the tab 816 and pull the tab in the direction shown by the arrow in FIG. 19C to progressively peel the aerosol-generating article away from the surface 8711 of the first planar wall portion 871.

The adhesive of the adhesive portion 841 used to adhere the second surface 853 of the frame 850 to the surface 8711 of the first planar wall portion 871 is different to the adhesive used to adhere the first surface of the frame 850 to the first sheet 810. More specifically, adhesive formulations are chosen which result in the bond between the first sheet 810 and the frame 850 being stronger than the bond between the first planar wall portion 871 and the frame 850. This helps to ensure that the frame 850 and the first sheet 810 remain adhered to each other when the user pulls on the tab 816 to peel the aerosol-generating article 800 away from the surface 8711 of the first planar wall portion 871.

FIGS. 20A and 20B show perspective schematic views of an alternative packaging assembly 90 in closed and partially open conditions respectively. Features of packaging assembly 90 in common with packaging assembly 80 are referred to with like reference signs but preceded with numeral “9” instead of numeral “8”. The packaging assembly 90 of FIGS. 20A-20B incorporates additional features to the packaging assembly 80 of FIGS. 18A-18B. More specifically, the container 970 includes a frangible interface 976 defined between the third and second planar wall portions 973, 972. The frangible interface 976 may incorporate a score line 977 along its length (as shown in FIGS. 20A and 20B) or be otherwise formed with a weakened region to allow the third and second planar wall portions 973, 972 to be separated from each other. When intact, the frangible interface 976 helps to secure the second planar wall portion 972 in its closed position against the surface of the third planar wall portion 973. FIGS. 20A and 20B show portions of adhesive 978a, 978b located at the corners of opposed surfaces of the second and third planar wall portions 972, 973. The portions of adhesive 978a, 978b may be a low tack adhesive based on acrylate copolymer microspheres. The corresponding portions of adhesive 978a, 978b provide a resealable bond therebetween.

A consumer would gain access to the aerosol-generating articles 900 by pulling on one of the corners 979 of the second planar wall portion 972 with sufficient force to tear the frangible interface 976 along score line 977 and overcome the adhesive bond between the portions 978a, 978b of adhesive retaining the second planar wall portion 972 in position against the third planar wall portion 973. The consumer would then unfold the second planar wall portion 972 about the first fold line 974 in the direction shown by the arrow in FIG. 20B. This would result in the aerosol-generating articles 900 attached to the underlying first planar wall portion 971 being partially exposed. The user would then unfold the third planar wall portion 973 about the second fold line 975 in the direction shown by the arrow in FIG. 20B to fully expose the aerosol-generating articles 900.

Table 3 below shows some exemplary ranges for the various dimensions of the container 870, 970 and aerosol-generating articles 800, 900:

TABLE 3

| | Preferable Range | More Preferable Range |
|---|---|---|
| Dimension | (millimetres) | (millimetres) |
| F | 9 to 30 | 13 to 27 |
| G | 6 to 27 | 10 to 24 |
| H | 2 to 11 | 3 to 7 |
| I | 19 to 54 | 24 to 45 |
| J | 12 to 47 | 17 to 38 |
| K | 4 to 22 | 6 to 17 |
| L | 10 to 45 | 16 to 30 |
| M | 9 to 30 | 12 to 23 |
| N | 26 to 63 | 31 to 52 |
| O | 1 to 5.5 | 1.25 to 3.5 |
| P | 0.15 to 4.5 | 0.5 to 2.5 |
| Q | 3 to 15 | 5 to 10 |
| R | 49 to 110 | 50 to 93 |
| S | 3 to 11 | 4.5 to 9 |
| T | 4 to 15 | 6 to 13 |
| U | 2 to 9 | 3 to 5 |
| V | 2 to 7 | 3 to 5.5 |
| W | 60 to 177 | 80 to 147 |
| X | 33 to 80 | 35 to 80 |
| Y | 127 to 280 | 135 to 270 |
| Z | 9 to 21 | 11 to 18 |

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. A packaging assembly comprising:
a container comprising first and second planar wall portions, the first planar wall portion comprising an attachment surface; and
an aerosol-generating article comprising opposed first and second outward facing surfaces, and a portion of sensorial media contained within the aerosol-generating article, the portion of sensorial media in fluid communication with an opening defined in the second outward facing surface of the aerosol-generating article, the second outward-facing surface of the aerosol-generating article releasably attached to the attachment surface of the first planar wall portion of the container to thereby close and seal the opening;
wherein the first and second planar wall portions are separated by a first fold region, the second planar wall portion foldable about the first fold region between a closed position and an open position, wherein in the closed position the second planar wall portion covers at least part of the first outward-facing surface of the aerosol-generating article;
wherein the container comprises a frangible interface for retaining the second planar wall portion in the closed position.

17. The packaging assembly according to claim 16, wherein a separation between the first and second outward-facing surfaces of the aerosol-generating article defines a thickness of the aerosol-generating article.

18. The packaging assembly according to claim 16, wherein the container comprises a third planar wall portion, the first and third planar wall portions separated by a second fold region, the third planar sheet portion foldable about the second fold region between a closed position and an open position, wherein in the closed position of the second and third planar sheet portions, one of the second and third planar sheet portions overlies the other of the second and third planar wall portions.

19. The packaging assembly according to claim 18, wherein the first, second and third planar wall portions are integrally formed as a single unitary sheet.

20. The packaging assembly according to claim 18, wherein in the closed position of the second and third planar wall portions, the second and third planar wall portions in combination cover all of the first outward-facing surface of the aerosol-generating article.

21. The packaging assembly according to claim 18, wherein the container comprises a frangible interface for retaining the third planar wall portion in the closed position.

22. The packaging assembly according to claim 18, wherein in the closed position of the second and third planar wall portions, opposing surfaces of the second and third planar wall portions are adhered to each other.

23. The packaging assembly according to claim 18, wherein the first planar wall portion has a permeability in a range of between 1 and 10 Coresta units.

24. The packaging assembly according to claim 18, wherein the releasable attachment of the second outward-facing surface of the aerosol-generating article to the attachment surface of the first planar wall portion of the container is configured as a peelable attachment.

25. The packaging assembly according to claim 24, wherein a plurality of the aerosol-generating articles are peelably attached to the attachment surface of the first planar wall portion to define an arrangement of one or more rows or columns.

26. The packaging assembly according to claim 18, wherein the aerosol-generating article comprises:
a frame comprising opposed first and second surfaces and a cavity, the opposed first and second surfaces defining a thickness of the frame, the frame enclosing a cavity, the cavity extending through the thickness of the frame to define the opening, the portion of sensorial media disposed within the cavity, the second surface of the frame defining the second outward-facing surface of the aerosol-generating article and being peelably attached to the attachment surface.

27. The packaging assembly according to claim 26, the aerosol-generating article further comprising a first sheet, the first sheet of the aerosol-generating article fixed to the first surface of the frame to overlie the cavity, wherein the first sheet defines the first outward-facing surface of the aerosol-generating article, optionally, wherein the first sheet comprises a tab for a user to engage therewith to thereby peel the aerosol-generating article away from the attachment surface.

28. The packaging assembly according to claim 27, wherein the fixation of the first sheet to the first surface of the frame is configured such that the first sheet remains fixed to the first surface of the frame if pulling on the tab to peel the aerosol-generating article away from the attachment surface.

29. The packaging assembly according to claim 16, wherein in a closed state of the container the packaging assembly has a thickness, wherein the thickness is 20 millimetres or less.

30. The packaging assembly according to claim 16, wherein the packaging assembly defines a generally parallelepiped profile.

31. The packaging assembly according to claim 18, wherein the releasable attachment of the second outward-facing surface of the aerosol-generating article to the attachment surface of the first planar wall portion of the container is configured as a peelable attachment, wherein the aerosol-generating article comprises a tab for a user to engage therewith to thereby peel the aerosol-generating article away from the attachment surface of the first planar wall portion of the container.

32. The packaging assembly according to claim 16, wherein in a closed state of the container the packaging assembly has a thickness, wherein the thickness is in a range of between 4 and 15 millimetres.
